(19) United States
(12) Patent Application Publication
(10) Pub. No.: US 2025/0341759 A1
(43) Pub. Date: Nov. 6, 2025

(54) OPTICAL ELEMENT DRIVING DEVICE AND CAMERA MODULE

(71) Applicant: ALPS ALPINE CO., LTD., Tokyo (JP)

(72) Inventor: Katsutoshi SUZUKI, Fukushima (JP)

(21) Appl. No.: 19/266,781

(22) Filed: Jul. 11, 2025

Related U.S. Application Data
(63) Continuation of application No. PCT/JP2024/001166, filed on Jan. 17, 2024.

(30) Foreign Application Priority Data
Jan. 20, 2023 (JP) 2023-007476

(51) Int. Cl. G03B 13/36; G03B 30/00

(52) U.S. Cl. CPC G03B 13/36; G03B 30/00

(57) ABSTRACT

An optical element driving device includes a fixed-side member including a base member, an optical element holding member, a first movable body, a second movable body, a first driver, a second driver, a first guide mechanism, and a second guide mechanism. The first guide mechanism includes a pair of first flat spring portions facing each other in parallel and separated in a first movement direction and extending in a second movement direction. The second guide mechanism includes a pair of second flat spring portions facing each other in parallel and separated in the second movement direction and extending in the first movement direction.

### CROSS-REFERENCE TO RELATED APPLICATIONS

This application is a continuation application of International Application No. PCT/JP2024/001166 filed on Jan. 17, 2024, and designated the U.S., which is based upon and claims priority to Japanese Patent Application No. 2023-007476 filed on Jan. 20, 2023, the entire contents of which are incorporated herein by reference.

### BACKGROUND

### 1. Technical Field

The present disclosure relates to an optical element driving device and a camera module mounted on a camera-equipped mobile device.

### 2. Description of Related Art

There is known a lens drive device including an X-axis actuator that moves an auxiliary body (first movable body) with respect to a base member (fixed-side member) in a direction of an X-axis perpendicular to an optical axis, and a Y-axis actuator that moves a movable body (second movable body) with respect to the auxiliary body (first movable body) in a direction of a Y-axis perpendicular to the optical axis and perpendicular to the X-axis (see Japanese Unexamined Patent Application Publication No. 2019-015849 (hereinafter “Patent Document 1”)). In this device, the X-axis actuator is provided on the base member, and the Y-axis actuator is provided on the auxiliary body (first movable body).

In the lens driving device described above, the substantially V-shaped metal plate is attached in the substantially V-shaped groove formed in the auxiliary body (first movable body) and extending along the X-axis direction. The substantially V-shaped groove is configured to abut against the columnar X-axis drive shaft via a substantially V-shaped metal plate. In other words, the substantially V-shaped metal plate that abuts against the X-axis drive shaft guides the movement of the auxiliary body (first movable body) in the X-axis direction. The same applies to the guide when the movable body (second movable body) moves along the Y-axis direction.

### SUMMARY

An optical element driving device according to an embodiment of the present invention includes a fixed-side member including a base member, an optical element holding member having a penetration portion that penetrates in an up-down direction and is capable of holding an optical element, a first movable body disposed on one surface side of the base member and configured to be movable in a first movement direction that intersects with the up-down direction with respect to the fixed-side member, a second movable body disposed on the one surface side of the base member, configured to be movable in a second movement direction that intersects with the up-down direction with respect to the first movable body and is perpendicular to the first movement direction, and configured to support the optical element holding member, a first driver configured to move the first movable body in the first movement direction, a second driver configured to move the second movable body in the second movement direction, a first guide mechanism configured to guide movement of the first movable body in the first movement direction, and a second guide mechanism configured to guide movement of the second movable body in the second movement direction. The first guide mechanism includes a pair of first flat spring portions facing each other in parallel and separated in the first movement direction and extending in the second movement direction. The pair of first flat spring portions have respective plate surfaces perpendicular to the first movement direction. One end portion of each of the pair of first flat spring portions in the second movement direction is fixed to the fixed-side member. The other end portion of each of the pair of first flat spring portions in the second movement direction is fixed to the first movable body. The second guide mechanism includes a pair of second flat spring portions facing each other in parallel and separated in the second movement direction and extending in the first movement direction. The pair of second flat spring portions have respective plate surfaces perpendicular to the second movement direction. One end portion of each of the pair of second flat spring portions in the first movement direction is fixed to the first movable body. The other end portion of each of the pair of second flat spring portions in the first movement direction is fixed to the second movable body.

### BRIEF DESCRIPTION OF THE DRAWINGS

FIG. 1 is an exploded perspective view of a camera module including an optical element driving device;

FIG. 2 is an exploded perspective view of the optical element driving device;

FIG. 3 is an exploded perspective view of the optical element driving device;

FIG. 4 is an exploded perspective view of the optical element driving device;

FIG. 5 is an exploded perspective view of a piezoelectric driver;

FIG. 6 is a diagram illustrating movement of the piezoelectric driver;

FIG. 7 is a front view of the optical element driving device in a state where a cover member is removed;

FIG. 8 is a right-side view of the optical element driving device in a state where the cover member is removed;

FIG. 9 is a left-side view of the optical element driving device in a state where the cover member is removed;

FIG. 10 is a rear side view of the optical element driving device in a state where the cover member is removed;

FIG. 11 is a top side view of the optical element driving device in a state where the cover member is removed;

FIG. 12 is a view illustrating the movement of the optical element holding member;

FIG. 13 is an exploded perspective view of another configuration example of the optical element driving device; and

FIG. 14 is an exploded perspective view of members constituting the optical element driving device illustrated in FIG. 13.

### DETAILED DESCRIPTION

In the above-described configuration, since a force that causes the movable body (optical element) to rotate in a plan view is generated and the movable body (optical element) is inclined, there is a concern that the movement of the movable body (optical element) is not appropriately guided.

It is therefore desirable to provide an optical element driving device capable of appropriately guiding the movement of an optical element.

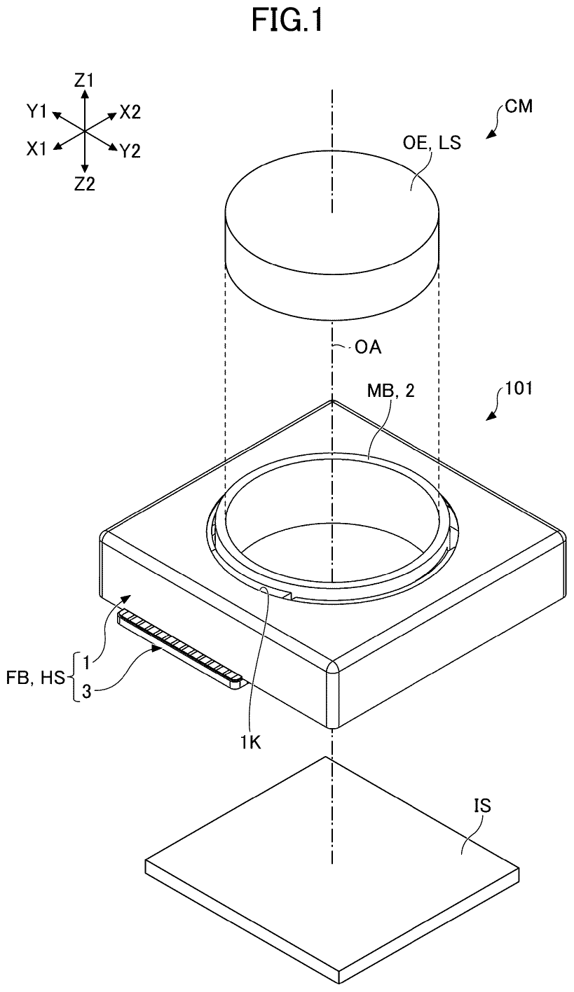

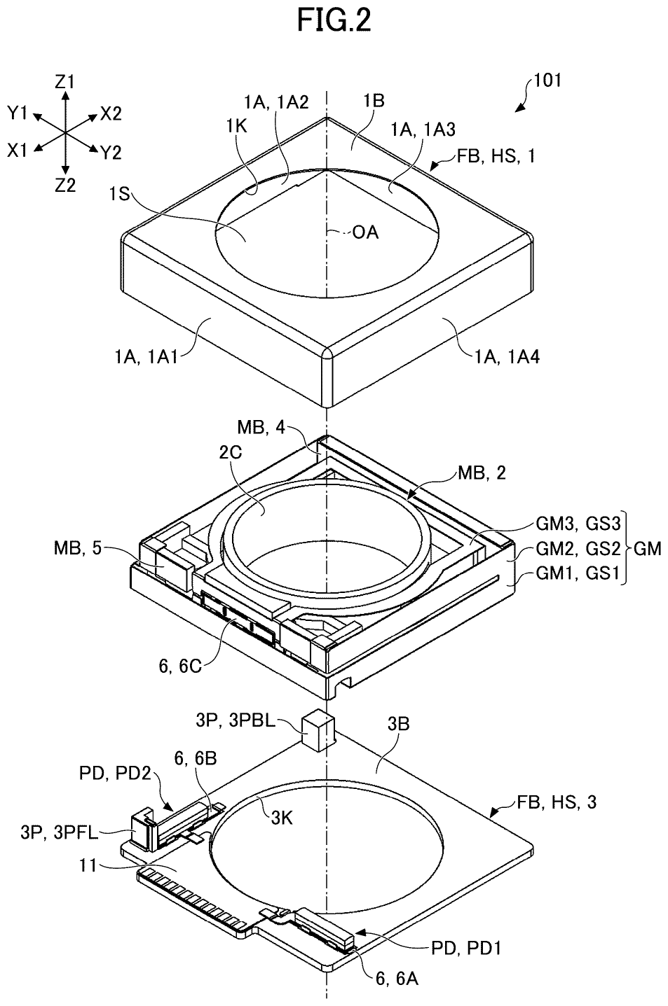

Hereinafter, an optical element driving device 101 according to an embodiment of the present disclosure will be described with reference to FIGS. 1 through 4. FIG. 1 is an exploded perspective view of a camera module CM including the optical element driving device 101. FIGS. 2 through 4 are an exploded perspective view of the optical element driving device 101.

In FIG. 1, X1 represents one direction of the X-axis included in the three-dimensional orthogonal coordinate system, and X2 represents the other direction of the X-axis. Y1 represents one direction of the Y-axis included in the three-dimensional orthogonal coordinate system, and Y2 represents the other direction of the Y-axis. Z1 represents one direction of the Z-axis included in the three-dimensional orthogonal coordinate system, and Z2 represents the other direction of the Z-axis. In FIG. 1, the X1 side of the optical element driving device 101 corresponds to the front side (front surface side) of the optical element driving device 101, and the X2 side of the optical element driving device 101 corresponds to the rear side (back surface side) of the optical element driving device 101. The Y1 side of the optical element driving device 101 corresponds to the left side of the optical element driving device 101, and the Y2 side of the optical element driving device 101 corresponds to the right side of the optical element driving device 101. The Z1 side of the optical element driving device 101 corresponds to the top side (object side) of the optical element driving device 101, and the Z2 side of the optical element driving device 101 corresponds to the bottom side (imaging element side) of the optical element driving device 101. The same applies to the other drawings.

The camera module CM includes an optical element driving device 101, a lens body LS, which is an example of an optical element OE, and an imaging element IS mounted on a substrate (not illustrated) so as to face the lens body LS. The optical element driving device 101 has a substantially rectangular parallelepiped outer shape and is disposed on the substrate on which the imaging sensor IS is mounted. The optical element OE may be a mirror, prism, diffraction grating, light-emitting element, light-receiving element, imaging element, optical filter, or the like. The optical element OE may be a combination of a plurality of types of elements. In a case where the optical element OE is an element other than the lens body LS, the imaging element IS may be omitted.

In the illustrated example, the optical element driving device 101 includes a fixed-side member FB and a movable-side member MB as illustrated in FIG. 2. In the illustrated example, the fixed-side member FB includes a cover member 1 and a base member 3, and the movable-side member MB includes an optical element holding member 2, a first movable body 4, and a second movable body 5. The fixed-side member FB and the movable-side member MB are connected by a guide mechanism GM. The movable-side member MB is supported by the guide mechanism GM so as to be guided in a predetermined movement direction. In the illustrated example, the predetermined movement direction includes a first movement direction (the X-axis direction) perpendicular to the optical axis direction, a second movement direction (the Y-axis direction) perpendicular to both the optical axis direction and the first movement direction, and a third movement direction (the Z-axis direction) parallel to the optical axis direction. The optical axis direction includes a direction of an optical axis OA of the lens body LS held by the optical element holding member 2 and a direction parallel to the optical axis OA. The lens body LS is, for example, a cylindrical lens barrel including at least one lens. The movable-side member MB is configured to be moved in a predetermined movement direction by a force generated by a piezoelectric driver PD, which is an example of a driver.

The cover member 1 is a member included in a part of the housing HS, and is configured to be able to cover the upper portion and the side portion of the movable-side member MB. In the illustrated example, as illustrated in FIG. 2, the cover member 1 has a substantially rectangular cylindrical outer peripheral wall 1A defining an accommodating portion 1S, and a flat and rectangular annular top plate 1B. Specifically, the outer peripheral wall 1A includes a first side plate 1A1, a second side plate 1A2, a third side plate 1A3, and a fourth side plate 1A4. The first side plate 1A1 and the third side plate 1A3 face each other, and the second side plate 1A2 and the fourth side plate 1A4 face each other. The second side plate 1A2 and the fourth side plate 1A4 extend perpendicularly to the first side plate 1A1 and the third side plate 1A3. In other words, the first side plate 1A1 and the third side plate 1A3 extend perpendicularly to the second side plate 1A2 and the fourth side plate 1A4. A circular opening 1K is formed in a central portion of the top plate 1B. The cover member 1 is formed by punching and drawing a metal plate. However, the cover member 1 may be formed of other materials, such as a synthetic resin.

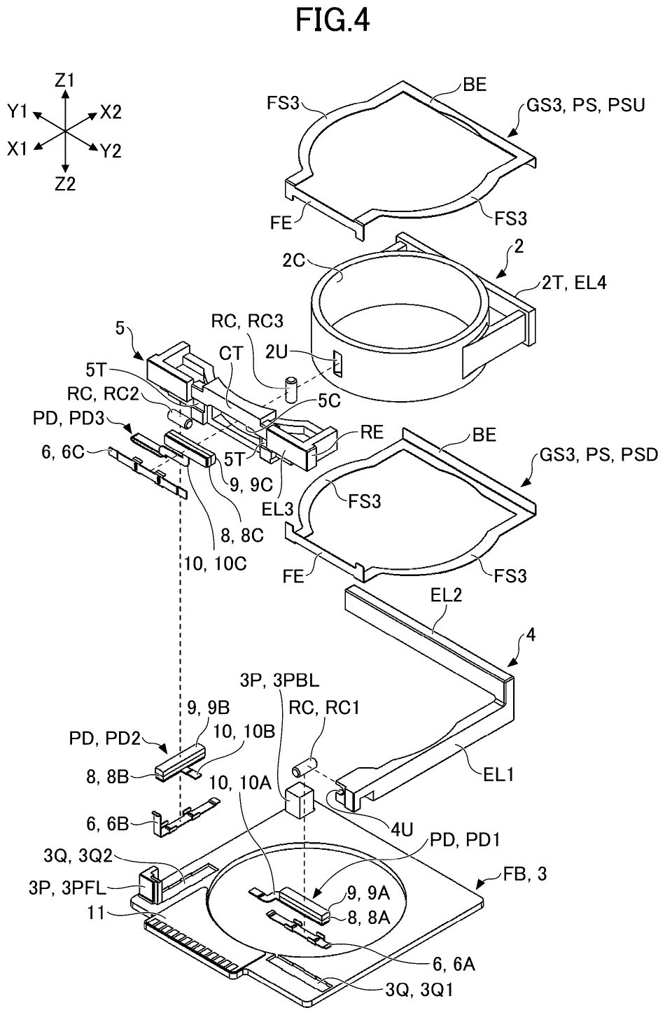

The base member 3 is a member included in a part of the housing HS. In the illustrated example, the base member 3 is formed of a synthetic resin. However, the base member 3 may be formed of metal. Specifically, as illustrated in FIG. 2, the base member 3 has a base 3B having a flat-plate, rectangular annular shape. A protrusion 3P protruding upward is formed at each of two of the four corners of the base 3B. A circular opening 3K is formed in the central portion of the base 3B. In particular, the protrusion 3P includes a left rear protrusion 3PBL and a left front protrusion 3PFL. As illustrated in FIG. 4, a recess 30 for accommodating the biasing member 6 is formed on the upper surface of the base 3B. Specifically, the base 3B is formed with a first recess 3Q1 for accommodating a first biasing member 6A and a second recess 302 for accommodating a second biasing member 6B. The base member 3 is bonded to the cover member 1 with an adhesive or the like to constitute the housing HS together with the cover member 1.

The optical element holding member 2 is configured to hold the optical element OE. In the illustrated example, the optical element holding member 2 is produced by injection molding of a synthetic resin such as a liquid crystal polymer (LCP). The optical element holding member 2 is configured to hold the lens body LS by fixing the lens body LS inside a cylindrical penetration portion 2C with an adhesive. The optical element holding member 2 has a protrusion 2T that protrudes in the radial direction (rearward) from the outer circumferential surface of the cylindrical portion in which the penetration portion 2C is formed. The protrusion 2T constitutes a fourth extending portion EL4 to which the guide mechanism GM (leaf spring member PS) is fixed.

The first movable body 4 is a member configured to be driven by the piezoelectric driver PD (first piezoelectric driver PD1) and to be guided by the guide mechanism GM (first guide mechanism GM1) to be movable in the first movement direction (the X-axis direction). In the illustrated example, the first movable body 4 is a member formed to be substantially L-shaped in a plan view along the up-down direction, and has a first extending portion EL1 extending in the first movement direction (the X-axis direction) and a second extending portion EL2 extending in the second movement direction (the Y-axis direction). The first movable body 4 is formed of a synthetic resin.

The second movable body 5 is a member configured to be driven by the piezoelectric driver PD (second piezoelectric driver PD2) and to be guided by the guide mechanism GM (second guide mechanism GM2) to be movable in the second movement direction (the Y-axis direction). In the illustrated example, the second movable body 5 is a member formed to have a substantially rectangular parallelepiped shape, and has a third extending portion EL3 extending in the second movement direction (the Y-axis direction). The second movable body 5 is formed of a synthetic resin. The third extending portion EL3 is disposed so as to face the second extending portion EL2 of the first movable body 4, with the optical element holding member 2 being interposed therebetween in the first movement direction (the X-axis direction). The front end surface (the end surface on the X1 side) of the central portion CT in the second movement direction (the Y-axis direction) of the third extending portion EL3 is positioned on the rear side (the X2 side) of the front end surface of the portion to the left of (on the Y1 side of) and the front end surface of the portion to the right of (on the Y2 side of) the central portion CT. A through hole 5C having a rectangular shape in a front view and penetrating in the X-axis direction is formed in the central portion CT in such a manner that a piezoelectric driver PD (third piezoelectric driver PD3) for driving the optical element holding member 2 can be disposed. In the central portion CT, a recessed attachment portion 5T is provided on each of the left side (the Y1 side) and the right side (the Y2 side) of the through hole 5C. The attachment portion 5T is used to fix the third biasing member 6C.

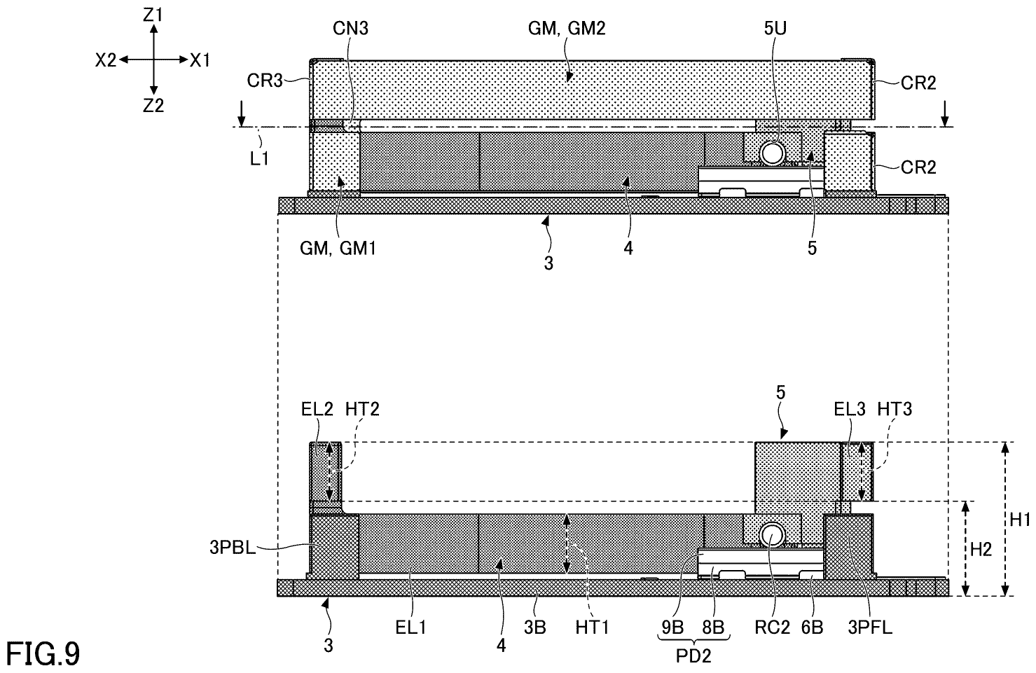

The receiving member RC is a member that receives a driving force generated by the piezoelectric driver PD. In the illustrated example, the receiving member RC is a columnar member formed of a metal, such as titanium copper or stainless steel, extending along a movement direction. The receiving member RC may be formed of another metal. The other metal may be either a magnetic metal or a nonmagnetic metal. In the illustrated example, the receiving member RC includes a first receiving member RC1, a second receiving member RC2, and a third receiving member RC3, as illustrated in FIG. 4. The first receiving member RC1 is fitted into a U-shaped groove 4U formed in a front end portion of the first movable body 4 and fixed with an adhesive, and is provided so as to be movable in the X-axis direction together with the first movable body 4. The second receiving member RC2 is fitted into a U-shaped groove 5U formed in a left end portion of the second movable body 5 (see the upper diagram in FIG. 9) and fixed with an adhesive, and is provided so as to be movable in the Y-axis direction together with the second movable body 5. The third receiving member RC3 is fitted into a U-shaped groove 2U formed on the front side of the outer circumferential surface of the cylindrical portion of the optical element holding member 2 in which the penetration portion 2C is formed, is fixed with an adhesive, and is provided so as to be movable in the Z-axis direction together with the optical element holding member 2.

The leaf spring member PS is configured to be able to support the optical element holding member 2 so as to be movable in the up-down direction. In the illustrated example, the leaf spring member PS includes an upper leaf spring member PSU and a lower leaf spring member PSD having the same structure, as illustrated in FIG. 4. Each of the upper leaf spring member PSU and the lower leaf spring member PSD has a substantially rectangular annular outer shape in a top view, and one end portion (front-side coupling portion FE) extending along the Y-axis direction is fixed to the second movable body 5 (third extending portion EL3) with an adhesive, and the other end portion (rear-side coupling portion BE) extending along the Y-axis direction is fixed to the protrusion 2T (fourth extending portion EL4) of the optical element holding member 2 with an adhesive.

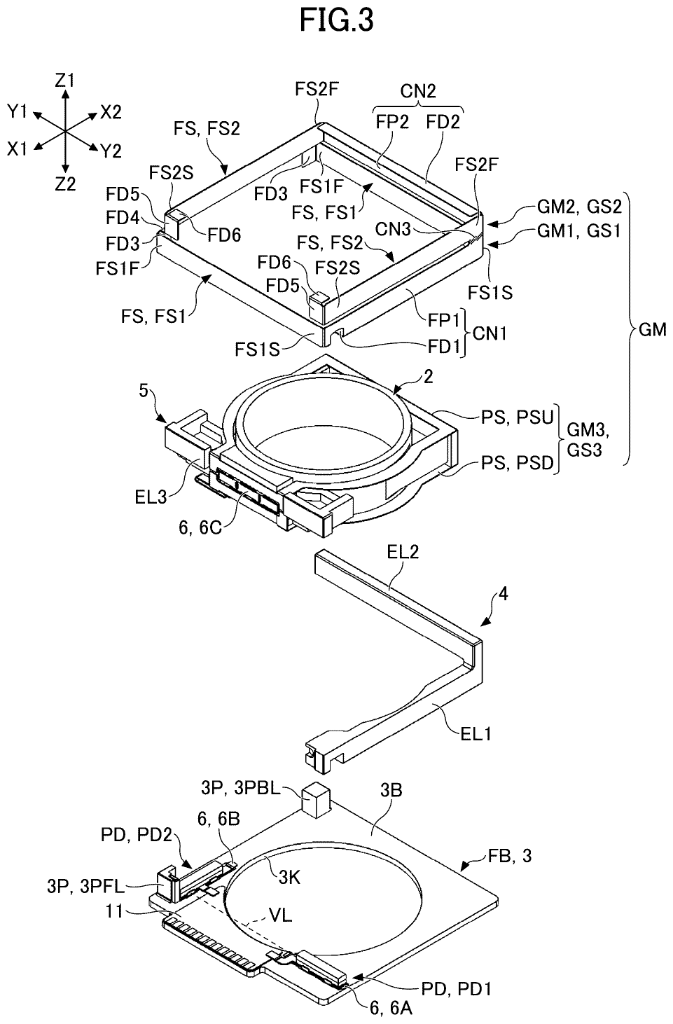

The biasing member 6 is configured to be able to bias the piezoelectric driver PD toward the receiving member RC. In the illustrated example, the biasing member 6 is constituted by a leaf spring member formed by pressing a metal plate made of titanium copper. The metal plate may be formed of other metals such as stainless steel. Specifically, the biasing member 6 includes a first biasing member 6A, a second biasing member 6B, and a third biasing member 6C. In the illustrated example, as illustrated in FIGS. 3 and 4, both ends of the first biasing member 6A are fixed to the upper surface of the base 3B of the base member 3 by an adhesive, and the remaining portion is accommodated in the first recess 301 so as not to come into contact with the bottom portion of the first recess 301. As described above, the first biasing member 6A is configured to be able to press the first piezoelectric driver PD1 toward the first receiving member RC1 fixed to the first movable body 4. As illustrated in FIGS. 3 and 4, the second biasing member 6B has one end fixed to the upper surface of the base 3B of the base member 3 with an adhesive, the other end fixed to the upper end surface of the left front protrusion 3PFL of the base member 3 with an adhesive, and the remaining portion accommodated in the second recess 302 so as not to contact the bottom portion of the second recess 302. As described above, the second biasing member 6B is configured to be able to press the second piezoelectric driver PD2 toward the second receiving member RC2 fixed to the second movable body 5. As illustrated in FIGS. 3 and 4, both ends of the third biasing member 6C are fixed to the attachment portion 5T of the second movable body 5 with an adhesive. The front surface (the surface on the X1 side) of both ends of the third biasing member 6C is covered with the front-side coupling portion FE of the leaf spring member PS fixed to the central portion CT of the third extending portion EL3. In other words, both ends of the third biasing member 6C are sandwiched between the attachment portion 5T of the second movable body 5 and the front-side coupling portion FE of the leaf spring member PS. The remaining portion of the third biasing member 6C is accommodated in the space between the upper leaf spring member PSU and the lower leaf spring member PSD so as not to contact the leaf spring member PS. As described above, the third biasing member 6C is configured to be able to press the third piezoelectric driver PD3 toward the third receiving member RC3 fixed to the optical element holding member 2.

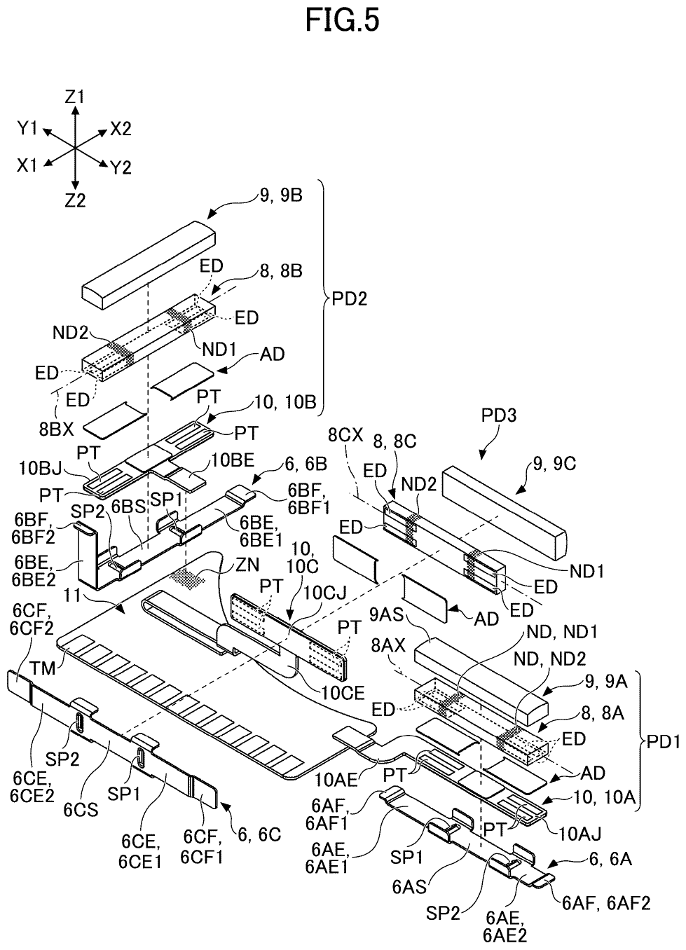

Next, details of the piezoelectric driver PD will be described with reference to FIG. 5. FIG. 5 is an exploded perspective view of the piezoelectric driver PD supported by the biasing member 6.

The piezoelectric driver PD is configured to be able to move the movable-side member MB along a predetermined movement direction. In the illustrated example, the piezoelectric driver PD is an example of a friction drive utilizing the drive system disclosed in U.S. Pat. No. 7,786,648 and includes a piezoelectric element 8, a contact member 9, and a flexible printed circuit 10. The piezoelectric driver PD is configured to be biased by the biasing member 6 and pressed against the receiving member RC (see FIG. 4). In other words, the contact member 9 of the piezoelectric driver PD and the receiving member RC are in contact with each other so as to be pressed against each other by the biasing member 6.

Specifically, the piezoelectric driver PD includes the first piezoelectric driver PD1 that moves the first movable body 4 in the first movement direction (the X-axis direction), the second piezoelectric driver PD2 that moves the second movable body 5 in the second movement direction (the Y-axis direction), and the third piezoelectric driver PD3 that moves the optical element holding member 2 in the third movement direction (the Z-axis direction).

The first piezoelectric driver PD1 includes a first piezoelectric element 8A, a first contact member 9A, and a first flexible printed circuit 10A, and is configured to be biased by the first biasing member 6A and pressed against the first receiving member RC1 (see FIG. 4) fixed to the first movable body 4.

The second piezoelectric driver PD2 includes a second piezoelectric element 8B, a second contact member 9B, and a second flexible printed circuit 10B, and is configured to be biased by the second biasing member 6B and pressed against the second receiving member RC2 (see FIG. 4) fixed to the second movable body 5.

The third piezoelectric driver PD3 includes a third piezoelectric element 8C, a third contact member 9C, and a third flexible printed circuit 10C, and is configured to be biased by the third biasing member 6C and pressed against the third receiving member RC3 (see FIG. 4) fixed to the optical element holding member 2.

In particular, each of the first piezoelectric element 8A, the second piezoelectric element 8B, and the third piezoelectric element 8C is configured to be able to realize bending vibration in accordance with an applied voltage. In the illustrated example, the first piezoelectric element 8A extends in the Y-axis direction along a first rotational axis 8AX, the second piezoelectric element 8B extends in the X-axis direction along a second rotational axis 8BX, and the third piezoelectric element 8C extends in the Y-axis direction along a third rotational axis 8CX. Each of the first piezoelectric element 8A, the second piezoelectric element 8B, and the third piezoelectric element 8C is configured to be able to realize bending vibration having two nodes (nodes ND). When the bending vibration is performed, the two nodes ND hardly vibrate. In FIG. 5, for the sake of clarity, the positions of the nodes ND in the first piezoelectric element 8A, the second piezoelectric element 8B, and the third piezoelectric element 8C are indicated by cross patterns. The positions of the nodes ND in the piezoelectric element 8 include a position of the first node ND1 and a position of the second node ND2. The positions of the nodes ND correspond to positions at a predetermined distance from the ends of the piezoelectric element 8. The predetermined distance is, for example, a distance of approximately one quarter of the entire length of the piezoelectric element 8.

The first flexible printed circuit 10A is a flexible printed circuit including a conductive pattern, and is configured to electrically connect an external voltage source (control circuit) and the first piezoelectric element 8A. In the illustrated example, the first flexible printed circuit 10A is configured to be able to apply a voltage to the first piezoelectric element 8A. Specifically, the first flexible printed circuit 10A includes a bonding portion 10AJ bonded to the first piezoelectric element 8A, and an extending portion 10AE extending from the bonding portion 10AJ in the Y1 direction. The first piezoelectric element 8A extends along the first rotational axis 8AX and is bonded to the upper surface (the Z1 side) of the first flexible printed circuit 10A with an adhesive AD. In the illustrated example, the first piezoelectric element 8A has electrodes ED at four corners of the lower surface (the Z2 side) respectively. The four electrodes ED of the first piezoelectric element 8A are respectively bonded to four connecting portions PT formed on the upper surface of the first flexible printed circuit 10A via an adhesive AD.

The second flexible printed circuit 10B is a flexible printed circuit including a conductive pattern, and is configured to electrically connect an external voltage source (control circuit) and the second piezoelectric element 8B. In the illustrated example, the second flexible printed circuit 10B is configured to be able to apply a voltage to the second piezoelectric element 8B. Specifically, the second flexible printed circuit 10B includes a bonding portion 10BJ bonded to the second piezoelectric element 8B, and an extending portion 10BE extending from the bonding portion 10BJ in the Y2 direction. The second piezoelectric element 8B extends along the second rotational axis 8BX and is bonded to the upper surface (the Z1 side) of the second flexible printed circuit 10B with an adhesive AD. In the illustrated example, the second piezoelectric element 8B has electrodes ED at four corners of the lower surface (the Z2 side) respectively. The four electrodes ED of the second piezoelectric element 8B are respectively bonded to four connecting portions PT formed on the upper surface of the second flexible printed circuit 10B via an adhesive AD.

Similarly, the third flexible printed circuit 10C is a flexible printed circuit including a conductive pattern, and is configured to electrically connect an external voltage source (control circuit) and the third piezoelectric element 8C. In the illustrated example, the third flexible printed circuit 10C is configured to be able to apply a voltage to the third piezoelectric element 8C. Specifically, the third flexible printed circuit 10C includes a bonding portion 10CJ bonded to the third piezoelectric element 8C, and an extending portion 10CE extending from the bonding portion 10CJ in the Z2 direction. The third piezoelectric element 8C extends along the third rotational axis 8CX and is bonded to the surface of the rear side (the X2 side) of the third flexible printed circuit 10C with an adhesive AD. In the illustrated example, the third piezoelectric element 8C has electrodes ED at four corners of the front surface (the X1 side) respectively. The four electrodes ED of the third piezoelectric element 8C are respectively bonded to four connecting portions PT formed on the surface of the rear side of the third flexible printed circuit 10C via an adhesive AD.

In the illustrated example, the adhesive AD is an anisotropic conductive film, and is heated and pressurized in a state of being disposed between the piezoelectric element 8 and the flexible printed circuit 10, and is fixed to each of the piezoelectric element 8 and the flexible printed circuit 10. Accordingly, the four electrodes ED of the piezoelectric element 8 and the four connecting portions PT which are a part of the conductive pattern of the flexible printed circuit 10 are individually electrically connected to each other. However, the adhesive AD may be a conductive adhesive, solder, or the like. In the illustrated example, the anisotropic conductive film as the adhesive AD is separated into two portions, but may be integrated into one portion having substantially the same size as the piezoelectric element 8.

In the illustrated example, the flexible printed circuit 10 has conductive patterns formed on both surfaces of the flexible printed circuit 10, and insulating films covering the conductive patterns are provided on both surfaces of the flexible printed circuit 10 except for the connecting portions PT and the connecting portion with the common flexible printed circuit 11. An insulating protective film is provided on a portion in contact with the piezoelectric element 8 and a portion in contact with the biasing member 6 in order to achieve more reliable insulation.

The common flexible printed circuit 11 is a flexible printed circuit including a conductive pattern, and is configured to electrically connect an external voltage source (control circuit) and the flexible printed circuit 10. In the illustrated example, the common flexible printed circuit 11 is configured in such a manner that the connecting portions of the first flexible printed circuit 10A, the second flexible printed circuit 10B, and the third flexible printed circuit 10C are connected to predetermined connecting regions by a conductive adhesive, solder, or the like. In FIG. 5, for the sake of clarity, a dot pattern is applied to a connection region ZN, which is a predetermined connection region to which the second flexible printed circuit 10B is connected. In FIG. 5, the first flexible printed circuit 10A and the third flexible printed circuit 10C are already connected to the common flexible printed circuit 11. The common flexible printed circuit 11 includes thirteen terminals TM. The thirteen terminals TM include four terminals TM corresponding to the four connecting portions PT formed on the first flexible printed circuit 10A, four terminals TM corresponding to the four connecting portions PT formed on the second flexible printed circuit 10B, four terminals TM corresponding to the four connecting portions PT formed on the third flexible printed circuit 10C, and one terminal TM corresponding to the ground potential. The common flexible printed circuit 11 may be a rigid printed circuit board.

The first piezoelectric driver PD1 is configured to be biased upward by the first biasing member 6A fixed to the base member 3 and pressed against the first receiving member RC1. In the illustrated example, the first biasing member 6A is configured to contact the surface of the lower side (the Z2 side) of the first flexible printed circuit 10A at positions corresponding to two nodes ND formed during bending vibration of the first piezoelectric element 8A (the positions of the first protrusion SP1 and the position of the second protrusion SP2). The bonding between the first biasing member 6A and the first flexible printed circuit 10A is realized by, for example, an adhesive.

The second piezoelectric driver PD2 is configured to be biased upward by the second biasing member 6B fixed to the base member 3 and pressed against the second receiving member RC2. In the illustrated example, the second biasing member 6B is configured to contact the surface of the lower side (the Z2 side) of the second flexible printed circuit 10B at positions corresponding to two nodes ND formed during bending vibration of the second piezoelectric element 8B (the positions of the first protrusion SP1 and the position of the second protrusion SP2). The bonding between the second biasing member 6B and the second flexible printed circuit 10B is realized by, for example, an adhesive.

The third piezoelectric driver PD3 is configured to be biased rearward by the third biasing member 6C fixed to the second movable body 5 and pressed against the third receiving member RC3. In the illustrated example, the third biasing member 6C is configured to contact the surface of the front side (the X1 side) of the third flexible printed circuit 10C at positions corresponding to two nodes ND formed during bending vibration of the third piezoelectric element 8C (the positions of the first protrusion SP1 and the position of the second protrusion SP2). The bonding between the third biasing member 6C and the third flexible printed circuit 10C is realized by, for example, an adhesive.

The biasing member 6 is constituted by a leaf spring member formed of a single metal plate. In the illustrated example, the first biasing member 6A includes a fixed portion 6AF fixed to the base member 3, a supporting portion 6AS supporting the first piezoelectric driver PD1, and an elastically deformable portion 6AE provided between the fixed portion 6AF and the supporting portion 6AS and capable of being elastically deformed. The second biasing member 6B includes a fixed portion 6BF fixed to the base member 3, a support portion 6BS supporting the second piezoelectric driver PD2, and an elastically deformable portion 6BE provided between the fixed portion 6BF and the support portion 6BS. Similarly, the third biasing member 6C includes a fixed portion 6CF fixed to the second movable body 5, a support portion 6CS supporting the third piezoelectric driver PD3, and an elastically deformable portion 6CE provided between the fixed portion 6CF and the support portion 6CS.

Specifically, the fixed portion 6AF includes a first fixed portion 6AF1 and a second fixed portion 6AF2, and the elastically deformable portion 6AE includes a first elastically deformable portion 6AE1 provided between the first fixed portion 6AF1 and the support portion 6AS, and a second elastically deformable portion 6AE2 provided between the second fixed portion 6AF2 and the support portion 6AS. The fixed portion 6BF includes a first fixed portion 6BF1 and a second fixed portion 6BF2, and the elastically deformable portion 6BE includes a first elastically deformable portion 6BE1 provided between the first fixed portion 6BF1 and the support portion 6BS, and a second elastically deformable portion 6BE2 provided between the second fixed portion 6BF2 and the support portion 6BS. Similarly, the fixed portion 6CF includes a first fixed portion 6CF1 and a second fixed portion 6CF2, and the elastically deformable portion 6CE includes a first elastically deformable portion 6CE1 provided between the first fixed portion 6CF1 and the support portion 6CS, and a second elastically deformable portion 6CE2 provided between the second fixed portion 6CF2 and the support portion 6CS.

The support portion 6AS and the support portion 6BS respectively include a first protrusion SP1 and a second protrusion SP2 that protrude upward (in the Z1 direction), and the support portion 6CS includes a first protrusion SP1 and a second protrusion SP2 that protrude rearward (in the X2 direction). In the illustrated example, the first protrusion SP1 and the second protrusion SP2 are draw beads formed by drawing. The first protrusion SP1 and the second protrusion SP2 may be formed by dowel forming, half-blanking, or the like. Therefore, recesses respectively corresponding to the first protrusion SP1 and the second protrusion SP2 are formed in each of the lower surface (surface on the Z2 side) of the support portion 6AS, the lower surface (surface on the Z2 side) of the support portion 6BS, and the front surface (surface on the X1 side) of the support portion 6CS. In particular, the first protrusion SP1 and the second protrusion SP2 are formed so as to extend perpendicular to the extending direction of the piezoelectric element 8. The positions where the first protrusion SP1 and the second protrusion SP2 are disposed are preferably positions corresponding to the nodes ND of the piezoelectric element 8, and are separated from each other in the extending direction of the piezoelectric element 8.

The first piezoelectric driver PD1 is attached to the first biasing member 6A in such a manner that the lower surface (surface on the Z2 side) of the bonding portion 10AJ of the first flexible printed circuit 10A is fixed to the support portion 6AS by an adhesive. Specifically, the first piezoelectric driver PD1 is attached to the first biasing member 6A in such a manner that the positions corresponding to the first node ND1 and the second node ND2 of the first piezoelectric element 8A in the bonding portion 10AJ and the first protrusion SP1 and the second protrusion SP2 in the support portion 6AS are fixed by an adhesive. In other words, the first piezoelectric driver PD1 is attached to the first biasing member 6A in such a manner that the support portion 6AS of the first biasing member 6A does not come into contact with a portion of the lower surface (surface on the Z2 side) of the bonding portion 10AJ that does not correspond to the first node ND1 and the second node ND2 of the first piezoelectric element 8A.

The second piezoelectric driver PD2 is attached to the second biasing member 6B in such a manner that the lower surface (surface on the Z2 side) of the bonding portion 10BJ of the second flexible printed circuit 10B is fixed to the support portion 6BS by an adhesive. Specifically, the second piezoelectric driver PD2 is attached to the second biasing member 6B in such a manner that the positions corresponding to the first node ND1 and the second node ND2 of the second piezoelectric element 8B in the bonding portion 10BJ and the first protrusion SP1 and the second protrusion SP2 in the support portion 6BS are fixed by an adhesive. In other words, the second piezoelectric driver PD2 is attached to the second biasing member 6B in such a manner that the support portion 6BS of the second biasing member 6B does not come into contact with a portion of the lower surface (surface on the Z2 side) of the bonding portion 10BJ that does not correspond to the first node ND1 and the second node ND2 of the second piezoelectric element 8B.

Similarly, the third piezoelectric driver PD3 is attached to the third biasing member 6C in such a manner that the front surface (surface on the X1 side) of the bonding portion 10CJ of the third flexible printed circuit 10C is fixed to the support portion 6CS by an adhesive. Specifically, the third piezoelectric driver PD3 is attached to the third biasing member 6C in such a manner that the positions corresponding to the first node ND1 and the second node ND2 of the third piezoelectric element 8C in the bonding portion 10CJ and the first protrusion SP1 and the second protrusion SP2 in the support portion 6CS are fixed by an adhesive. In other words, the third piezoelectric driver PD3 is attached to the third biasing member 6C in such a manner that the support portion 6CS of the third biasing member 6C does not come into contact with a portion of the front surface (surface on the X1 side) of the bonding portion 10CJ that does not correspond to the first node ND1 and the second node ND2 of the third piezoelectric element 8C.

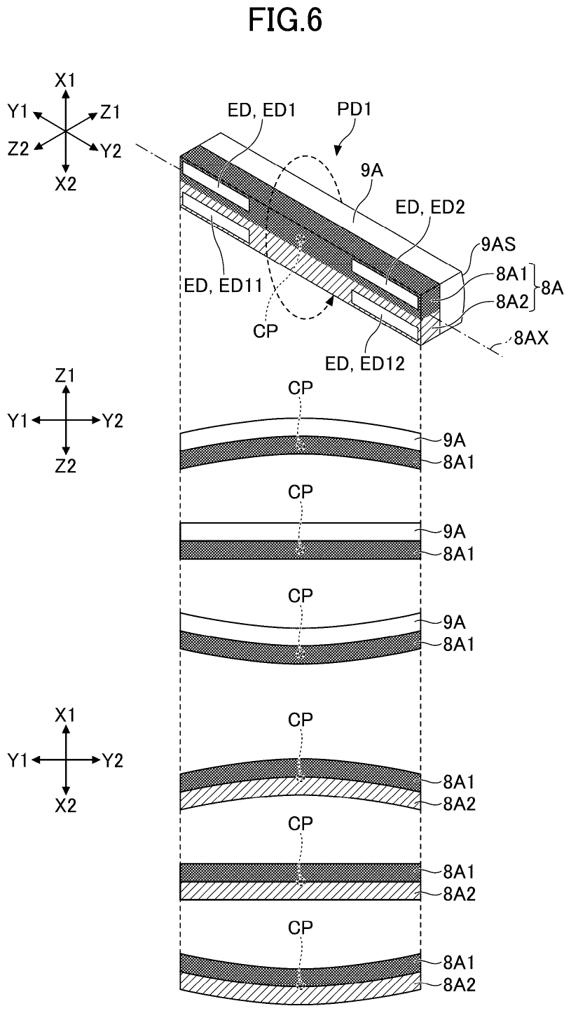

Next, details of the first piezoelectric driver PD1 will be described with reference to FIG. 6. FIG. 6 is a diagram illustrating the first piezoelectric element 8A and the first contact member 9A that constitute the first piezoelectric driver PD1. In FIG. 6, the first flexible printed circuit 10A is not illustrated for the sake of clarity. Specifically, the uppermost figure in FIG. 6 is a perspective view of the first piezoelectric element 8A and the first contact member 9A, the second, third, and fourth figures from the top in FIG. 6 are front views of the first piezoelectric element 8A and the first contact member 9A, and the fifth, sixth, and seventh figures from the top in FIG. 6 are bottom views of the first piezoelectric element 8A and the first contact member 9A. In FIG. 6, the bent shape of the first piezoelectric driver PD1 is exaggerated for easy understanding. The following description with reference to FIG. 6 relates to the movement of the first piezoelectric driver PD1, but may be similarly applied to the movement of each of the second piezoelectric driver PD2 and the third piezoelectric driver PD3. This is because the first piezoelectric driver PD1, the second piezoelectric driver PD2, and the third piezoelectric driver PD3 have the same configuration.

In the illustrated example, the first piezoelectric element 8A has two portions (a first portion 8A1 and a second portion 8A2) arranged in the first movement direction (the X-axis direction), and two electrodes ED to which a voltage can be individually applied are formed in the two portions. Specifically, a first electrode ED1 and a second electrode ED2 are formed in the first portion 8A1, and a first electrode ED11 and a second electrode ED12 are formed in the second portion 8A2. In FIG. 6, for the sake of clarity, the first portion 8A1 is indicated by a dot pattern, and the second portion 8A2 is indicated by a diagonal line pattern.

When a voltage is separately applied to the first portion 8A1 and the second portion 8A2 at respective appropriate timings, the first piezoelectric driver PD1 can cause the first piezoelectric element 8A to perform bending vibration (circular motion) in such a manner that, for example, a trajectory drawn by a center point CP, which is a predetermined point of the first piezoelectric element 8A (first piezoelectric driver PD1), becomes a circular trajectory centered on the first rotational axis 8AX. In other words, the first piezoelectric element 8A can realize movement (circular motion) in which the center point CP draws a circle. In the illustrated example, the center point CP of the first piezoelectric element 8A is the center of gravity of the first piezoelectric element 8A, and the first rotational axis 8AX is parallel to the Y-axis. The center point CP of the circular motion may be located within the first contact member 9A fixed to the first piezoelectric element 8A. This is because the first contact member 9A also performs a circular motion together with the first piezoelectric element 8A. The first piezoelectric driver PD1 can switch the movement direction (rotation direction) of the center point CP that follows a circular orbit between the clockwise direction and the counterclockwise direction viewed from the Y1 side by applying a voltage to the first portion 8A1 and the second portion 8A2 at an appropriate timing. By switching the rotation direction, the first piezoelectric driver PD1 can switch the movement direction of the first receiving member RC1 (and the first movable body 4 (movable-side member MB) to which the first receiving member RC1 is fixed) along the first movement direction (the X-axis direction). The circle (i.e., a circular orbit) drawn by the center point CP is not necessarily a complete circle (i.e., a perfect circle), but may be a substantially circular shape.

The dotted arrow drawn around the first piezoelectric element 8A in the uppermost diagram of FIG. 6 represents an example of bending vibration of the first piezoelectric element 8A (circular motion in which the first piezoelectric element 8A rotates in the clockwise direction as viewed from the Y1 side around the first rotation axis 8AX while the first piezoelectric element 8A being bent). In this case, the movable-side member MB including the first receiving member RC1 being in contact with the first contact member 9A of the first piezoelectric driver PD1 moves forward (in the X1 direction). Although not indicated by an arrow, the first piezoelectric element 8A can also rotate counterclockwise as viewed from the Y1 side around the first rotation axis 8AX while being bent. In this case, the movable-side member MB including the first receiving member RC1 being in contact with the first contact member 9A of the first piezoelectric driver PD1 moves rearward (in the X2 direction).

In other words, the first movable body 4 to which the first receiving member RC1 is attached is moved forward (in the X1 direction) when the rotation direction of the center point CP of the first piezoelectric element 8A is clockwise in a left-side view, and is moved rearward (in the X2 direction) when the rotation direction of the center point CP of the first piezoelectric element 8A is counterclockwise.

The first contact member 9A is attached to the first piezoelectric element 8A and is configured to be in contact with the first receiving member RC1. In the illustrated example, the first contact member 9A is bonded to the surface of the upper side of the first piezoelectric element 8A with an adhesive so as to cover the entire surface of the upper side (the Z1 side) of the first piezoelectric element 8A. The first contact member 9A is formed of a metal such as titanium copper or stainless steel, and is configured to have an appropriate thicknesses so as to be able to perform bending vibration (circular motion) along with bending vibration (circular motion) of the first piezoelectric element 8A. In the illustrated example, the first contact member 9A is a friction plate formed of stainless steel. The first contact member 9A extends so as to have the same length as the length of the first piezoelectric element 8A in the same direction (the Y-axis direction) as the extending direction of the first piezoelectric element 8A. The first contact member 9A is configured to contact the first receiving member RC1 at a central portion in the extending direction. Specifically, the first contact member 9A is configured to come into contact with the first receiving member RC1 at a portion where bending vibration (circular motion) has the maximum magnitude (a portion corresponding to an antinode of the bending vibration). In the illustrated example, the surface 9AS of the first contact member 9A on the side (the Z1 side) which comes into contact with the first receiving member RC1 is a convex curved surface which is convex to the Z1 side. In other words, the surface 9AS is configured to form a surface having one convex portion.

The reason why the first receiving member RC1 made of metal and the first contact member 9A made of metal are brought into contact with each other is to prevent wear of the movable-side member MB (first movable body 4) due to contact between the movable-side member MB (first movable body 4) made of a synthetic resin and the first contact member 9A made of metal. As long as the first receiving member RC1 and the first contact member 9A are in contact with each other, the length of the first contact member 9A in the Y-axis direction does not have to be the same as the length of the first piezoelectric element 8A in the Y-axis direction. For example, the length of the first contact member 9A in the Y-axis direction may be smaller than the length of the first piezoelectric element 8A in the Y-axis direction. It is preferable that the length of the first contact member 9A in the extending direction (the Y-axis direction) is equal to or longer than the length of the first piezoelectric element 8A.

When the first electrode ED1 is connected to a high potential and the second electrode ED2 is connected to a low potential in such a manner that the first portion 8A1 contracts, and the first electrode ED11 is connected to a high potential and the second electrode ED12 is connected to a low potential in such a manner that the second portion 8A2 contracts, the first piezoelectric element 8A and the first contact member 9A each bend so as to protrude upward (the Z1 side), as illustrated in the second diagram from the top in FIG. 6. Hereinafter, the state of the first piezoelectric driver PD1 when each of the first piezoelectric element 8A and the first contact member 9A is convex upward is also referred to as an “upward convex state”.

When the first and second electrodes ED1 and ED2 are connected to the same potential in such a manner that the first portion 8A1 does not expand or contract, or when the application of voltage to the first and second electrodes ED1 and ED2 is stopped, and the first and second electrodes ED11 and ED12 and are connected to the same potential in such a manner that the second portion 8A2 does not expand or contract, or when the application of voltage to the first and second electrodes ED11 and ED12 is stopped, each of the first piezoelectric element 8A and the first contact member 9A extends linearly as illustrated in the third and sixth diagrams from the top in FIG. 6. Hereinafter, the state of the first piezoelectric driver PD1 when each of the first piezoelectric element 8A and the first contact member 9A extends linearly is also referred to as a “neutral state”. The state when the application of voltage is stopped is also referred to as an “initial state”.

When the first electrode ED1 is connected to a low potential and the second electrode ED2 is connected to a high potential in such a manner that the first portion 8A1 expands, and the first electrode ED11 is connected to a low potential and the second electrode ED12 is connected to a high potential in such a manner that the second portion 8A2 expands, the first piezoelectric element 8A and the first contact member 9A each bend so as to protrude downward (the Z2 side), as illustrated in the fourth diagram from the top in FIG. 6. Hereinafter, the state of the first piezoelectric driver PD1 when each of the first piezoelectric element 8A and the first contact member 9A is convex downward is also referred to as a “downward convex state”.

When the first electrode ED1 is connected to a low potential and the second electrode ED2 is connected to a high potential in such a manner that the first portion 8A1 expands, and the first electrode ED11 is connected to a high potential and the second electrode ED12 is connected to a low potential in such a manner that the second portion 8A2 contracts, the first piezoelectric element 8A and the first contact member 9A each bend so as to protrude frontward (the X1 side), as illustrated in the fifth diagram from the top in FIG. 6. Hereinafter, the state of the first piezoelectric driver PD1 when each of the first piezoelectric element 8A and the first contact member 9A is convex frontward is also referred to as a “frontward convex state”.

When the first electrode ED1 is connected to a high potential and the second electrode ED2 is connected to a low potential in such a manner that the first portion 8A1 contracts, and the first electrode ED11 is connected to a low potential and the second electrode ED12 is connected to a high potential in such a manner that the second portion 8A2 expands, the first piezoelectric element 8A and the first contact member 9A each bend so as to protrude rearward (the X2 side), as illustrated in the seventh diagram from the top in FIG. 6. Hereinafter, the state of the first piezoelectric driver PD1 when each of the first piezoelectric element 8A and the first contact member 9A is convex rearward is also referred to as a “rearward convex state”.

When a voltage is applied between the first electrode ED1 (first electrode ED11) and the second electrode ED2 (second electrode ED12) in order to expand or contract the first portion 8A1 (second portion 8A2) in the extending direction of the first portion 8A1, the first contact member 9A fixed to the one surface of the first piezoelectric element 8A does not change the dimensions of the first contact member 9A in the extending direction of the first contact member 9A. Therefore, the first piezoelectric driver PD1 is deformed into the above-described state. The first flexible printed circuit 10A fixed to the other surface of the first piezoelectric element 8A can be deformed following the change in shape of the first piezoelectric element 8A.

The first piezoelectric driver PD1 can realize a circular motion rotating clockwise when viewed from the Y1 side by repeatedly changing the state in the order of the upward convex state, the frontward convex state, the downward convex state, and the rearward convex state. The first piezoelectric driver PD1 can realize a circular motion rotating counterclockwise when viewed from the Y1 side by repeatedly changing the state in the order of the upward convex state, the rearward convex state, the downward convex state, and the frontward convex state. The first piezoelectric driver PD1 can realize the up-down movement by repeatedly changing the state in the order of the upward convex state and the downward convex state, and can realize the front-back movement by repeatedly changing the state in the order of the frontward convex state and the rearward convex state.

In the illustrated example, the first piezoelectric driver PD1 is configured such that the first electrode ED1 is connected to a high potential and the second electrode ED2 is connected to a low potential in such a manner that the first portion 8A1 contracts, and the first electrode ED1 is connected to a low potential and the second electrode ED2 is connected to a high potential in such a manner that the first portion 8A1 expands, but may be configured such that the first electrode ED1 is connected to a low potential and the second electrode ED2 is connected to a high potential in such a manner that the first portion 8A1 contracts, and the first electrode ED1 is connected to a high potential and the second electrode ED2 is connected to a low potential in such a manner that the first portion 8A1 expands. The same applies to the second portion 8A2.

In the illustrated example, the second piezoelectric element 8B of the second piezoelectric driver PD2 is disposed so as to extend in the X-axis direction. Therefore, regarding the second piezoelectric driver PD2, the “frontward convex state” of the first piezoelectric driver PD1 described above corresponds to a “leftward convex state” which is a state of the second piezoelectric driver PD2 when each of the second piezoelectric element 8B and the second contact member 9B is convex to the left side, and the “rearward convex state” of the first piezoelectric driver PD1 described above corresponds to a “rightward convex state” which is a state of the second piezoelectric driver PD2 when each of the second piezoelectric element 8B and the second contact member 9B is convex to the right side. The second piezoelectric driver PD2 can realize the up-down movement by repeatedly changing the state in the order of the upward convex state and the downward convex state, and can realize the left-right movement by repeatedly changing the state in the order of the leftward convex state and the rightward convex state.

The guide mechanism GM is configured to guide the movable-side member MB moving relative to the fixed-side member FB along a predetermined movement direction. In the illustrated example, the guide mechanism GM includes a first guide mechanism GM1, a second guide mechanism GM2, and a third guide mechanism GM3.

The first guide mechanism GM1 is configured to be able to guide the movement of the first movable body 4 in a first movement direction (the X-axis direction). The second guide mechanism GM2 is configured to be able to guide the movement of the second movable body 5 in a second movement direction (the Y-axis direction). The third guide mechanism GM3 is configured to be able to guide the movement of the optical element holding member 2 in a third movement direction (the Z-axis direction).

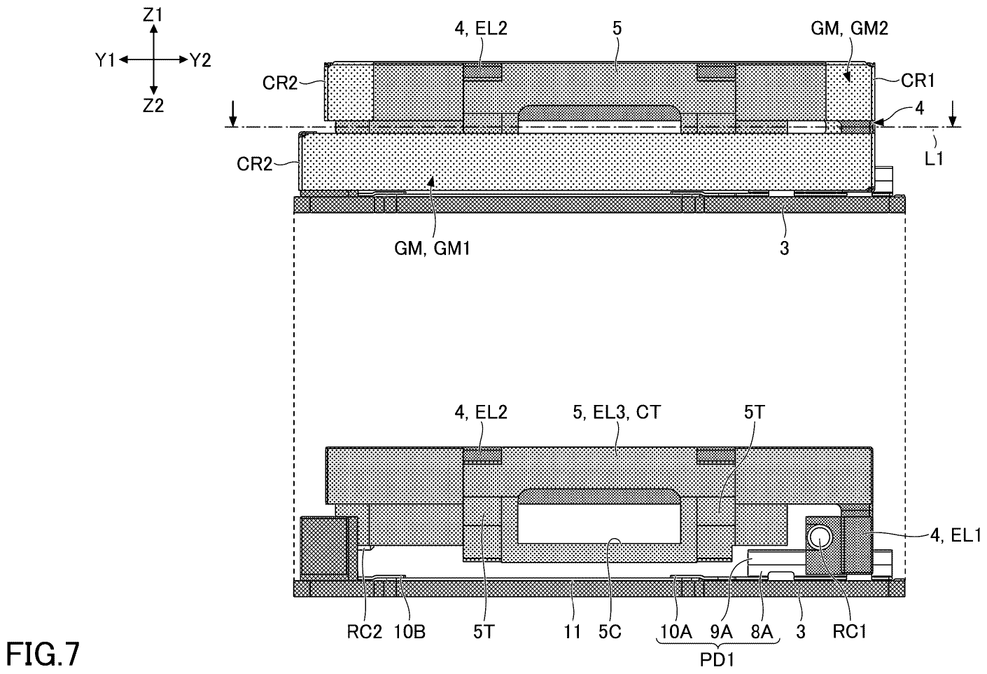

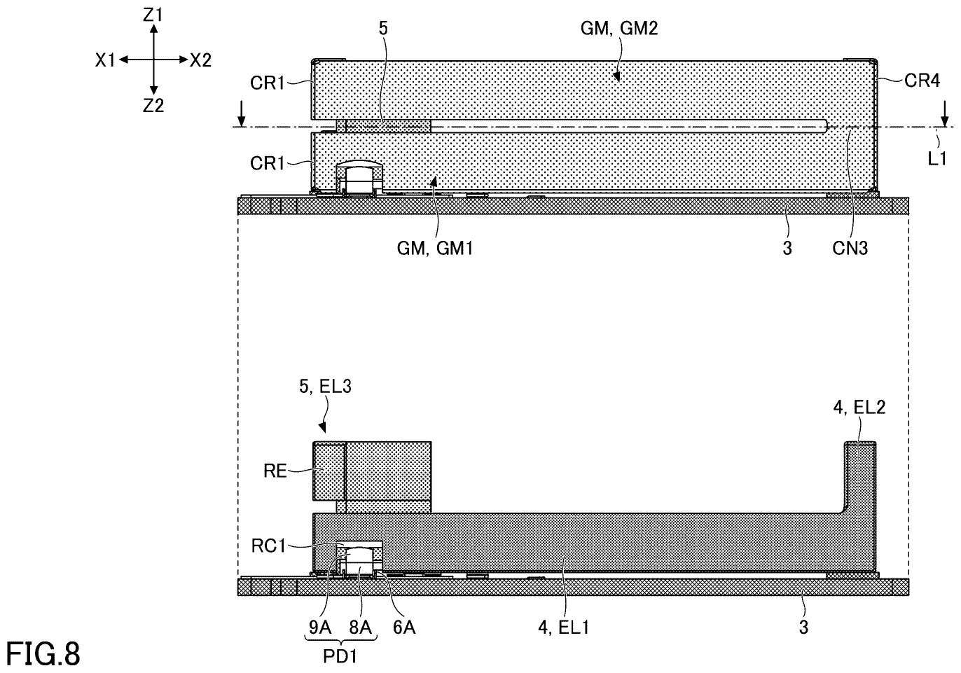

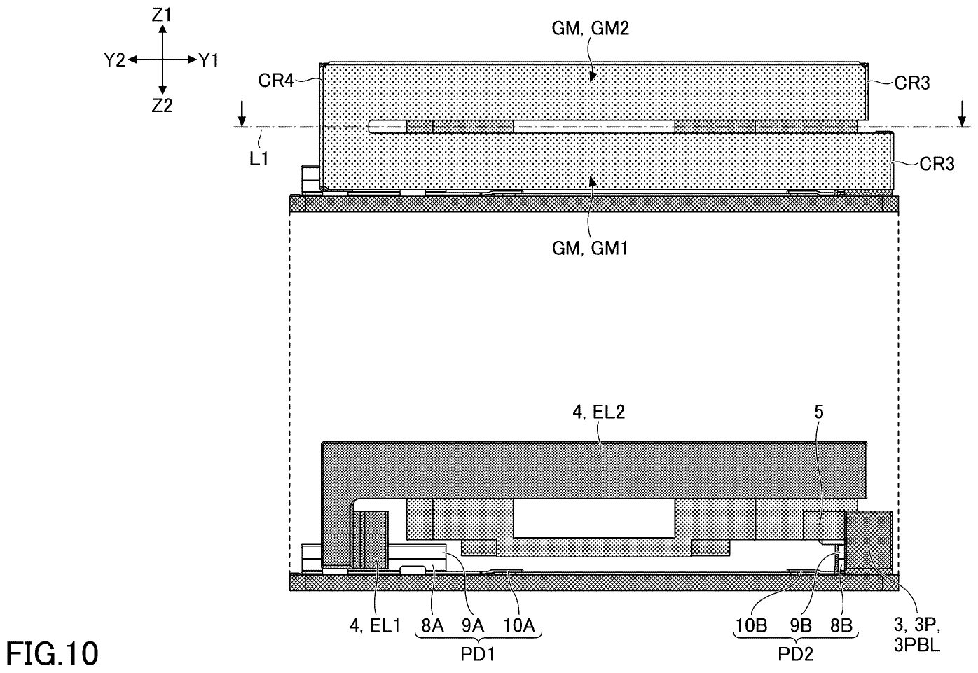

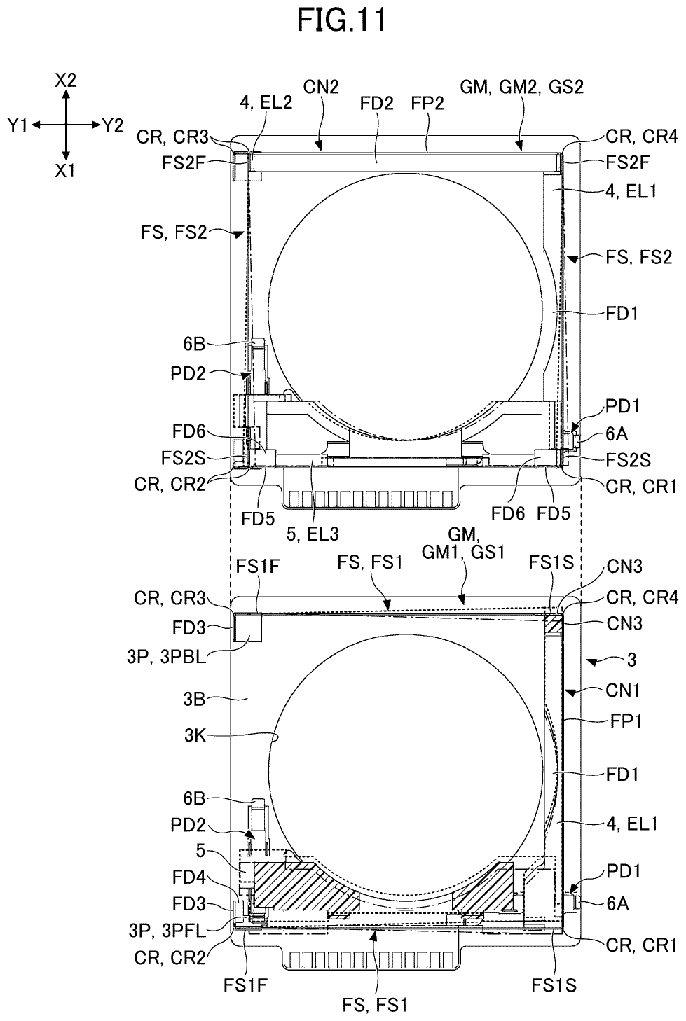

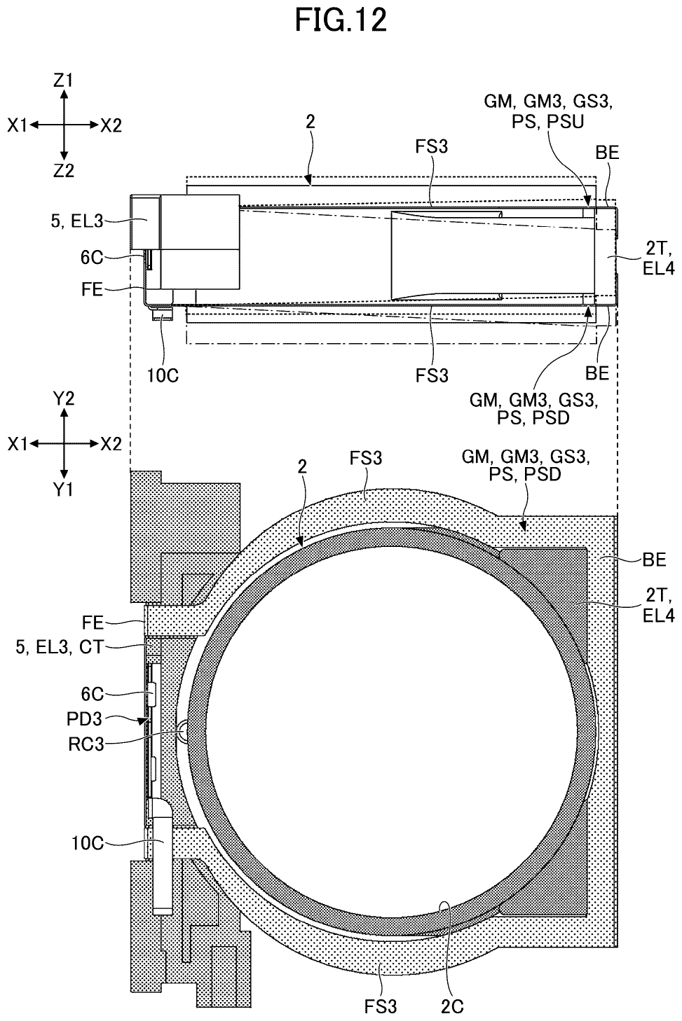

Next, a connection relationship between the movable-side member MB and the guide mechanism GM will be described with reference to FIGS. 7 through 12. FIG. 7 is a front view of the optical element driving device 101 in a state where the cover member 1 is removed. FIG. 8 is a right-side view of the optical element driving device 101 in a state where the cover member 1 is removed. FIG. 9 is a left-side view of the optical element driving device 101 in a state where the cover member 1 is removed. FIG. 10 is a rear side view of the optical element driving device 101 in a state where the cover member 1 is removed. FIG. 11 is a top side view of the optical element driving device 101 in a state where the cover member 1 is removed. FIG. 12 is a diagram of the optical element holding member 2, the third biasing member 6C, the third piezoelectric driver PD3, and the third guide mechanism GM3. In FIGS. 7 through 11, the optical element holding member 2, the third biasing member 6C, the third piezoelectric driver PD3, and the third guide mechanism GM3 are not illustrated for the sake of clarity. In FIGS. 7 through 10, a cross pattern is applied to the base member 3, a fine dot pattern is applied to the first movable body 4, a coarse dot pattern is applied to the second movable body 5, and a further coarse dot pattern is applied to the guide mechanism GM.

Specifically, the upper diagram of each of FIGS. 7 through 11 is a diagram of the optical element driving device 101 in a state where the cover member 1 is removed, and the lower diagram of each of FIGS. 7 through 10 is a diagram of the optical element driving device 101 in a state where the first guide mechanism GM1 and the second guide mechanism GM2 are further removed. The lower diagram of FIG. 11 is a diagram illustrating a cross section of the optical element driving device 101 when an imaginary plane parallel to the XY plane including the section line L1 indicated by the alternate long and short dashed line in the upper diagram of each of FIGS. 7 through 10 is viewed from above. The upper diagram of FIG. 12 is a right-side view of the optical element holding member 2, the third biasing member 6C, the third piezoelectric driver PD3, and the third guide mechanism GM3, and the lower diagram of FIG. 12 is a bottom view of the optical element holding member 2, the third biasing member 6C, the third piezoelectric driver PD3, and the third guide mechanism GM3. In the lower diagram of FIG. 12, for the sake of clarity, a fine dot pattern is applied to the optical element holding member 2, a coarse dot pattern is applied to the second movable body 5, and a further coarse dot pattern is applied to the guide mechanism GM.

As illustrated in the lower drawing of FIG. 11, the first guide mechanism GM1 is formed of a metal plate as a first guide spring member GS1, and has a first coupling portion CN1 and a pair of first flat spring portions FS1. Specifically, the first guide mechanism GM1 has a pair of first flat spring portions FS1 that are spaced apart from each other in the first movement direction (the X-axis direction), face each other in parallel, and extend in the second movement direction (the Y-axis direction). Each of the plate surfaces of the pair of first flat spring portions FS1 is perpendicular to the first movement direction (the X-axis direction). One end portion FS1F of each of the pair of first flat spring portions FS1 in the second movement direction (the Y-axis direction) is fixed to the fixed-side member FB (protrusion 3P of the base member 3) by an adhesive, and the other end portion FS1S of each of the pair of first flat spring portions FS1 in the second movement direction (the Y-axis direction) is fixed to the first movable body 4 by an adhesive. Furthermore, the first coupling portion CN1 is configured to couple the other end portions FS1S of the pair of first flat spring portions FS1. Specifically, the first coupling portion CN1 includes a first flat-plate-shaped portion FP1 that extends in the first movement direction (the X-axis direction) and has a plate surface perpendicular to the second movement direction (the Y-axis direction), and a first bent portion FD1 that is bent inward substantially perpendicularly from a lower end portion of the first flat-plate-shaped portion FP1. The “inner side” means a side close to the optical element OE, that is, a side opposite to the outer side, which is a side far from the optical element OE. The first movable body 4 has a first extending portion EL1 having a substantially rectangular parallelepiped shape extending in the first movement direction (the X-axis direction) and a second extending portion EL2 having a substantially rectangular parallelepiped shape extending in the second movement direction (the Y-axis direction). The inner surface (rear surface) of the other end portion FS1S of the first flat spring portion FS1 on the front side, the inner surface (front surface) of the other end portion FS1S of the first flat spring portion FS1 on the rear side, the inner surface (left surface) of the first flat-plate-shaped portion FP1 of the first coupling portion CN1, and the upper surface of the first bent portion FD1 of the first coupling portion CN1 are fixed to the front surface, the rear surface, the right surface, and the lower surface of the first extending portion EL1, respectively, by an adhesive.

The first piezoelectric driver PD1 repeatedly changes its state in the order of the upward convex state, the frontward convex state, the downward convex state, and the rearward convex state, thereby realizing a circular motion rotating clockwise when viewed from the Y1 side, and as illustrated by a figure drawn by the alternate long and short dashed line in the lower diagram of FIG. 11, the first movable body 4 can be moved to the front (the X1 direction). The figure indicated by the alternate long and short dashed line in the lower diagram of FIG. 11 illustrates the positions of the first extending portion EL1 of the first movable body 4, the second movable body 5, and the first guide mechanism GM1 when the first movable body 4 moves forward (in the X1 direction) by a predetermined amount. The first guide mechanism GM1 can move the first movable body 4 forward (in the X1 direction) in parallel by bending the first flat spring portions FS1 in such a manner that the other end portions FS1S move forward (in the X1 direction). The second movable body 5 is moved forward (in the X1 direction) together with the first movable body 4.

The first piezoelectric driver PD1 repeatedly changes its state in the order of the upward convex state, the rearward convex state, the downward convex state, and the frontward convex state, thereby realizing a circular motion rotating counterclockwise when viewed from the Y1 side, and as illustrated by a figure drawn by the dashed line in the lower diagram of FIG. 11, the first movable body 4 can be moved rearward (the X2 direction). The figure indicated by the dashed line in the lower diagram of FIG. 11 illustrates the positions of the first extending portion EL1 of the first movable body 4, the second movable body 5, and the first guide mechanism GM1 when the first movable body 4 moves rearward (in the X2 direction) by a predetermined amount. The first guide mechanism GM1 can move the first movable body 4 rearward (in the X2 direction) in parallel by bending the first flat spring portions FS1 in such a manner that the other end portions FS1S move rearward (in the X2 direction). The second movable body 5 is moved rearward (in the X2 direction) together with the first movable body 4.

When the piezoelectric driver PD moves the movable-side member MB along the first movement direction (the X-axis direction), the second piezoelectric driver PD2 repeatedly changes the state in the order of the downward convex state, the neutral state, the upward convex state (or the neutral state), and the neutral state, in synchronization with the change in the state of the first piezoelectric driver PD1. In the illustrated example, the second piezoelectric driver PD2 repeatedly changes its state so as to be in the downward convex state when the first piezoelectric driver PD1 is in the upward convex state, to be in the neutral state when the first piezoelectric driver PD1 is in the frontward convex state, to be in the upward convex state (or the neutral state) when the first piezoelectric driver PD1 is in the downward convex state, and to be in the neutral state when the first piezoelectric driver PD1 is in the rearward convex state. This is to prevent a friction force (second friction force) caused by the contact between the second receiving member RC2 and the second contact member 9B from acting on the second receiving member RC2 when a driving force (first friction force) caused by the contact between the first receiving member RC1 and the first contact member 9A acts on the first receiving member RC1. In other words, this is to prevent the second friction force from acting as a force that cancels the driving force (first frictional force). Furthermore, this is to support the movable-side member MB (second movable body 5) by bringing the second receiving member RC2 and the second contact member 9B into contact with each other in the case where the first receiving member RC1 and the first contact member 9A are not in contact with each other.

The piezoelectric driver PD can move the first movable body 4 along the first movement direction (the X-axis direction), and then, can return the first movable body 4 to the neutral position by using a restoring force of the first flat spring portions FS1 in a bent state. The neutral position of the first movable body 4 is a position of the first movable body 4 when the first flat spring portions FS1 are not bent. For example, the piezoelectric driver PD can return the first movable body 4 to the neutral position by changing the state of the first piezoelectric driver PD1 to the downward convex state and changing the state of the second piezoelectric driver PD2 to the downward convex state. This is because a state in which the first receiving member RC1 and the first contact member 9A are not in contact with each other and a state in which the second receiving member RC2 and the second contact member 9B are not in contact with each other can be realized. In other words, this is because a force (first frictional force) for holding the first movable body 4 at its current position and a force (second frictional force) for holding the second movable body 5 at its current position can be simultaneously eliminated.

As illustrated in the upper drawing of FIG. 11, the second guide mechanism GM2 is formed of a metal plate as a second guide spring member GS2, and has the second coupling portion CN2 and a pair of second flat spring portions FS2. Specifically, the second guide mechanism GM2 has a pair of second flat spring portions FS2 that are spaced apart from each other in the second movement direction (the Y-axis direction), face each other in parallel, and extend in the first movement direction (the X-axis direction). Each of the plate surfaces of the pair of second flat spring portions FS2 is perpendicular to the second movement direction (the Y-axis direction). One end portion FS2F of each of the pair of second flat spring portions FS2 in the first movement direction (the X-axis direction) is fixed to the second extending portion EL2 of the first movable body 4 by an adhesive, and the other end portion FS2S of each of the pair of second flat spring portions FS2 in the first movement direction (the X-axis direction) is fixed to the second movable body 5 by an adhesive. Furthermore, the second coupling portion CN2 is configured to couple the one end portions FS2F of the pair of second flat spring portions FS2. Specifically, the second coupling portion CN2 includes a second flat-plate-shaped portion FP2 that extends in the second movement direction (the Y-axis direction) and has a plate surface perpendicular to the first movement direction (the X-axis direction), and a second bent portion FD2 that is bent inward substantially perpendicularly from an upper end portion of the second flat-plate-shaped portion FP2. The inner surface (right surface) of the one end portion FS2F of the second flat spring portion FS2 on the left side, the inner surface (left surface) of the one end portion FS2F of the second flat spring portion FS2 on the right side, the inner surface (front surface) of the second flat-plate-shaped portion FP2 of the second coupling portion CN2, and the lower surface of the second bent portion FD2 of the second coupling portion CN2 are fixed to the left surface, the right surface, the rear surface, and the upper surface of the second extending portion EL2, respectively, by an adhesive.

The second piezoelectric driver PD2 repeatedly changes its state in the order of the upward convex state, the rightward convex state, the downward convex state, and the leftward convex state, thereby realizing a circular motion rotating clockwise when viewed from the X1 side, and as illustrated by a figure drawn by the alternate long and short dashed line in the upper diagram of FIG. 11, the second movable body 5 can be moved to the right (the Y2 direction). The figure indicated by the alternate long and short dashed line in the upper diagram of FIG. 11 illustrates the positions of the second movable body 5 and the second guide mechanism GM2 when the second movable body 5 moves rightward (in the Y2 direction) by a predetermined amount. The second guide mechanism GM2 can move the second movable body 5 rightward (in the Y2 direction) in parallel by bending the second flat spring portions FS2 in such a manner that the other end portions FS2S move rightward (in the Y2 direction).

The second piezoelectric driver PD2 repeatedly changes its state in the order of the upward convex state, the leftward convex state, the downward convex state, and the rightward convex state, thereby realizing a circular motion rotating counterclockwise when viewed from the X1 side, and as illustrated by a figure drawn by the dashed line in the upper diagram of FIG. 11, the second movable body 5 can be moved to the left (the Y1 direction). The figure indicated by the dashed line in the upper diagram of FIG. 11 illustrates the positions of the second movable body 5 and the second guide mechanism GM2 when the second movable body 5 moves leftward (in the Y1 direction) by a predetermined amount. The second guide mechanism GM2 can move the second movable body 5 leftward (in the Y1 direction) in parallel by bending the second flat spring portions FS2 in such a manner that the other end portions FS2S move leftward (in the Y1 direction).

When the piezoelectric driver PD moves the movable-side member MB (second movable body 5) along the second movement direction (the Y-axis direction), the first piezoelectric driver PD1 does not need to change its state as in the case of moving the movable-side member MB (first movable body 4) along the first movement direction (the X-axis direction). Specifically, the first piezoelectric driver PD1 may be in a neutral state. This is because the second movable body 5 needs to be moved together with the first movable body 4 in the case where the piezoelectric driver PD moves the movable-side member MB (the first movable body 4) along the first movement direction (the X-axis direction), whereas the first movable body 4 does not need to be moved together with the second movable body 5 in the case where the piezoelectric driver PD moves the movable-side member MB (the second movable body 5) along the second movement direction (the Y-axis direction). In other words, this is because the piezoelectric driver PD (the second piezoelectric driver PD2) can move only the second movable body 5 along the second movement direction (the Y-axis direction) regardless of the first movable body 4.

The piezoelectric driver PD can move the second movable body 5 along the second movement direction (the Y-axis direction), and then, can return the second movable body 5 to the neutral position by using a restoring force of the second flat spring portions FS2 in a bent state. The neutral position of the second movable body 5 is a position of the second movable body 5 when the second flat spring portions FS2 are not bent. For example, the piezoelectric driver PD can return the second movable body 5 to the neutral position by changing the state of the second piezoelectric driver PD2 to the downward convex state. This is because a state in which the second receiving member RC2 and the second contact member 9B are not in contact with each other can be realized. In other words, this is because a force (second frictional force) for holding the second movable body 5 at the position can be eliminated.

As illustrated in the upper diagram of FIG. 12, the third guide mechanism GM3 is formed of a metal plate as a third guide spring member GS3, and includes an upper leaf spring member PSU and a lower leaf spring member PSD. Specifically, each of the upper leaf spring member PSU and the lower leaf spring member PSD has a pair of third flat spring portions FS3 that are spaced apart from each other in the third movement direction (the Z-axis direction), face each other in parallel, and extend in the first movement direction (the X-axis direction). Each of the plate surfaces of the pair of third flat spring portions FS3 is perpendicular to the third movement direction (the Z-axis direction). The front-side coupling portion FE coupling the front end portions of the pair of third flat spring portions FS3 is fixed to the third extending portion EL3 of the second movable body 5 by an adhesive, and the rear-side coupling portion BE coupling the rear end portions of the pair of third flat spring portions FS3 is fixed to the protrusion 2T (fourth extending portion EL4) of the optical element holding member 2 by an adhesive.

The third piezoelectric driver PD3 repeatedly changes its state in the order of the upward convex state, the rearward convex state, the downward convex state, and the frontward convex state, thereby realizing a circular motion rotating clockwise when viewed from the Y2 side, and as illustrated by a figure drawn by the alternate long and short dashed line in the upper diagram of FIG. 12, the optical element holding member 2 can be moved downward (the Z2 direction). The figure indicated by the alternate long and short dashed line in the upper diagram of FIG. 12 illustrates the positions of the optical element holding member 2 and the third guide mechanism GM3 when the optical element holding member 2 moves downward (in the Z2 direction) by a predetermined amount. The third guide mechanism GM3 can move the optical element holding member 2 downward (in the Z2 direction) in parallel by bending the third flat spring portions FS3 in such a manner that the rear-side coupling portion BE moves downward (in the Z2 direction).

The third piezoelectric driver PD3 repeatedly changes its state in the order of the upward convex state, the frontward convex state, the downward convex state, and the rearward convex state, thereby realizing a circular motion rotating counterclockwise when viewed from the Y2 side, and as illustrated by a figure drawn by the dashed line in the upper diagram of FIG. 12, the optical element holding member 2 can be moved upward (the Z1 direction). The figure indicated by the dashed line in the upper diagram of FIG. 12 illustrates the positions of the optical element holding member 2 and the third guide mechanism GM3 when the optical element holding member 2 moves upward (in the Z1 direction) by a predetermined amount. The third guide mechanism GM3 can move the optical element holding member 2 upward (in the Z1 direction) in parallel by bending the third flat spring portions FS3 in such a manner that the rear-side coupling portion BE moves upward (in the Z1 direction).

When the piezoelectric driver PD moves the movable-side member MB (optical element holding member 2) along the third movement direction (the Z-axis direction), the first piezoelectric driver PD1 and the second piezoelectric driver PD2 do not need to change their states. Specifically, the first piezoelectric driver PD1 and the second piezoelectric driver PD2 may be in a neutral state. This is because it is not necessary to move the first movable body 4 and the second movable body 5 together with the optical element holding member 2 in the case where the piezoelectric driver PD moves the movable-side member MB (optical element holding member 2) along the third movement direction (the Z-axis direction). In other words, this is because the piezoelectric driver PD (the third piezoelectric driver PD3) can move only the optical element holding member 2 along the third movement direction (the Z-axis direction) regardless of the first movable body 4 and the second movable body 5.

The piezoelectric driver PD can move the optical element holding member 2 along the third movement direction (the Z-axis direction), and then, can return the optical element holding member 2 to the neutral position by using a restoring force of the third flat spring portions FS3 in a bent state. The neutral position of the optical element holding member 2 is a position of the optical element holding member 2 when the third flat spring portions FS3 are not bent. For example, the piezoelectric driver PD can return the optical element holding member 2 to the neutral position by changing the state of the third piezoelectric driver PD3 to the frontward convex state. This is because a state in which the third receiving member RC3 and the third contact member 9C are not in contact with each other can be realized. In other words, this is because a force (third frictional force) for holding the optical element holding member 2 at the position can be eliminated.

In the optical element driving device 101 described above, the piezoelectric element 8 is connected to an external voltage supply source (control circuit) via the flexible printed circuit 10 and the common flexible printed circuit 11. When a voltage is applied to the piezoelectric element 8, the piezoelectric element 8 (piezoelectric driver PD) performs bending vibration and generates a force for moving the movable-side member MB along a predetermined movement direction. This force is caused by a frictional force accompanying the contact between the receiving member RC attached to the movable-side member MB and the contact member 9 joined to the piezoelectric element 8. The optical element driving device 101 can realize an automatic focusing function by moving the movable-side member MB along the Z-axis direction on the Z1 side (object side) of the imaging sensor IS using this force. Specifically, the optical element driving device 101 can realize macro photographing by moving the optical element holding member 2 (lens body LS) in a direction away from the imaging sensor IS, and can realize infinity-focus photographing by moving the optical element holding member 2 (lens body LS) in a direction approaching the imaging sensor IS. The optical element driving device 101 can realize a camera shake correction function by moving the optical element holding member 2 (lens body LS) in parallel to the XY plane.

As described above, the optical element driving device 101 according to the embodiment of the present disclosure as illustrated in FIG. 3 includes: the fixed-side member FB including the base member 3; the optical element holding member 2 having the penetration portion 2C that penetrates in an up-down direction and is capable of holding the optical element OE; the first movable body 4 disposed on one surface side of the base member 3 and configured to be movable in the first movement direction (the X-axis direction) intersecting with an up-down direction with respect to the fixed-side member FB (base member 3); the second movable body 5 disposed on one surface side of the base member 3 and configured to be movable in the second movement direction (the Y-axis direction) that intersects the up-down direction with respect to the first movable body 4 and is perpendicular to the first movement direction (the X-axis direction), and configured to support the optical element holding member 2; the first piezoelectric driver PD1 configured to move the first movable body 4 in the first movement direction, the second piezoelectric driver PD2 configured to move the second movable body 5 in the second movement direction. Both the first piezoelectric driver PD1 and the second piezoelectric driver PD2 are provided on the base member 3.

In this configuration, both the first piezoelectric driver PD1 and the second piezoelectric driver PD2 are provided on the same member (the base member 3). For this reason, this configuration brings about an effect that the producibility of the optical element driving device 101 can be enhanced as compared to a configuration in which the first piezoelectric driver PD1 and the second piezoelectric driver PD2 are provided on different members. Furthermore, with this configuration, it is easy to dispose at least a part of the first piezoelectric driver PD1 and the second piezoelectric driver PD2 at the same height position in the up-down direction. For this reason, this configuration brings about an effect that at least one of downsizing, height reduction, or the like of the optical element driving device 101 can be realized.

As illustrated in FIG. 4, the first piezoelectric driver PD1 may include the first piezoelectric element 8A extending in the second movement direction (the Y-axis direction) and the first contact member 9A fixed to one surface (upper surface) of the first piezoelectric element 8A. The first movable body 4 may have the first receiving member RC1 that can contact the first contact member 9A. The second piezoelectric driver PD2 may include the second piezoelectric element 8B extending in the first movement direction (the X-axis direction) and the second contact member 9B fixed to one surface (upper surface) of the second piezoelectric element 8B. The second movable body 5 may have the second receiving member RC2 that can contact the second contact member 9B. The optical element driving device 101 may include a first biasing member 6A that brings the first contact member 9A and the first receiving member RC1 into contact with each other, and the second biasing member 6B that brings the second contact member 9B and the second receiving member RC2 into contact with each other. In this case, the first piezoelectric driver PD1 and the second piezoelectric driver PD2 may be configured such that the contact portions of the first contact member 9A and the second contact member 9B face upward.

This configuration brings about an effect that the productivity of the optical element driving device 101 can be enhanced. This is because the contact portions of the first contact member 9A and the second contact member 9B of both the first piezoelectric driver PD1 and the second piezoelectric driver PD2 face upward, and thus the first piezoelectric driver PD1 and the second piezoelectric driver PD2 can be assembled to the base member 3 from the same side (for example, the upper side or the lower side).

As illustrated in FIG. 4, the optical element driving device 101 may include the first biasing member 6A that is provided in a state in which a part of the first biasing member 6A is fixed to the base member 3 and that brings the first contact member 9A and the first receiving member RC1 of the first piezoelectric driver PD1 into contact with each other so as to push each other. The optical element driving device 101 may include the second biasing member 6B that is provided in a state in which a part thereof is fixed to the base member 3 and that brings the second contact member 9B and the second receiving member RC2 of the second piezoelectric driver PD2 into contact with each other so as to push each other. In this case, the first piezoelectric driver PD1 may be supported by the base member 3 via the first biasing member 6A. The second piezoelectric driver PD2 may be supported by the base member 3 via the second biasing member 6B.

This configuration brings about an effect that the productivity of the optical element driving device 101 can be further enhanced. This is because a unit in which the first piezoelectric driver PD1 and the first biasing member 6A are fixed can be assembled to the base member 3 (base 3B), and a unit in which the second piezoelectric driver PD2 and the second biasing member 6B are fixed can be assembled to the base member 3 (base 3B). In other words, the first piezoelectric driver PD1 and the first biasing member 6A can be unitized (integrated), and the second piezoelectric driver PD2 and the second biasing member 6B can be unitized (integrated). In this case, the unit in which the first piezoelectric driver PD1 and the first biasing member 6A are fixed and the unit in which the second piezoelectric driver PD2 and the second biasing member 6B are fixed are assembled to the base member 3 (base 3B) from the same side (for example, the upper side or the lower side).

As illustrated in FIG. 5, the first piezoelectric driver PD1 may include the first flexible printed circuit 10A on which the connecting portions PT connected to the electrodes ED of the first piezoelectric element 8A are formed and which is fixed to the other surface of the first piezoelectric element 8A. The first biasing member 6A may be formed of a metal plate such as a leaf spring member and may be configured to support the first piezoelectric driver PD1 at two positions (the position of the first protrusion SP1 and the position of the second protrusion SP2) separated in the second movement direction (the Y-axis direction). The second piezoelectric driver PD2 may include the second flexible printed circuit 10B on which the connecting portions PT connected to the electrodes ED of the second piezoelectric element 8B are formed and which is fixed to the other surface of the second piezoelectric element 8B. The second biasing member 6B may be formed of a metal plate such as a leaf spring member and may be configured to support the second piezoelectric driver PD2 at two positions (the position of the first protrusion SP1 and the position of the second protrusion SP2) separated in the first movement direction (the X-axis direction).

This configuration brings about an effect that a voltage can be easily applied to the piezoelectric element 8 by using the flexible printed circuit 10. This is because the conductive path is simplified as compared to the case where the flexible printed circuit 10 is not used. In addition, this configuration brings about an effect that the flexible printed circuit 10 follows a change in shape of the piezoelectric element 8 that is bent (deformed) by application of a voltage to the piezoelectric element 8, and it is possible to suppress the member constituting the conductive path from hindering the deformation of the piezoelectric element 8.

As illustrated in FIG. 6, the first piezoelectric element 8A may have two portions (a first portion 8A1 and a second portion 8A2) arranged in the first movement direction (the X-axis direction), and two electrodes ED may be formed on each of the two portions so that a voltage can be individually applied to each of the two portions. In the illustrated example, the first electrode ED1 and the second electrode ED2 are formed in the first portion 8A1, and the first electrode ED11 and the second electrode ED12 are formed in the second portion 8A2. Similarly, the second piezoelectric element 8B may have two portions arranged in the second movement direction, and two electrodes ED may be formed on each of the two portions so that a voltage can be individually applied to each of the two portions. The same applies to the third piezoelectric element 8C.

With this configuration, each of the first piezoelectric element 8A, the second piezoelectric element 8B, and the third piezoelectric element 8C can realize bending vibration in two directions perpendicular to the extending direction (up-down movement, left-right movement, or front-back movement) and circular motion which is a combination of these bending vibration movements.

The base member 3 may have the opening 3K as illustrated in FIG. 3. The extending direction (the Y-axis direction) of the first piezoelectric driver PD1 and the extending direction (the X-axis direction) of the second piezoelectric driver PD2 may be perpendicular to each other. In this case, one of the first piezoelectric driver PD1 or the second piezoelectric driver PD2 (the second piezoelectric driver PD2 in the illustrated example) may be disposed on a virtual straight line VL along the extending direction of the other of the first piezoelectric driver PD1 or the second piezoelectric driver PD2 (the first piezoelectric driver PD1 in the illustrated example) when viewed along the up-down direction.

This configuration brings about an effect that the space efficiency in the housing HS can be enhanced. This is because the first piezoelectric driver PD1 and the second piezoelectric driver PD2 can be installed in a relatively small region on the upper surface of the base 3B of the base member 3, compared to a case where one of the first piezoelectric driver PD1 or the second piezoelectric driver PD2 is not on the virtual straight line VL.

As illustrated in FIG. 3, the optical element driving device 101 may include the first guide mechanism GM1 that guides the movement of the first movable body 4 in the first movement direction (the X-axis direction) and the second guide mechanism GM2 that guides the movement of the second movable body 5 in the second movement direction (the Y-axis direction). The first guide mechanism GM1 may include a pair of first flat spring portions FS1 (first parallel springs) that are spaced apart from each other in the first movement direction, face each other in parallel, and extend in the second movement direction. In this case, the pair of first flat spring portions FS1 may have their plate surfaces perpendicular to the first movement direction, one end portion FS1F of each of the pair of first flat spring portions FS1 in the second movement direction may be fixed to the fixed-side member FB, and the other end portion FS1S of each of the pair of first flat spring portions FS1 in the second movement direction may be fixed to the first movable body 4. The second guide mechanism GM2 may include a pair of second flat spring portions FS2 (second parallel springs) that are spaced apart from each other in the second movement direction, face each other in parallel, and extend in the first movement direction. In this case, the pair of second flat spring portions FS2 may have their plate surfaces perpendicular to the second movement direction, one end portion FS2F of each of the pair of second flat spring portions FS2 in the first movement direction may be fixed to the first movable body 4, and the other end portion FS2S of each of the pair of second flat spring portions FS2 in the first movement direction may be fixed to the second movable body 5.

This configuration brings about an effect that the movement of the first movable body 4 along the first movement direction can be appropriately and stably guided by the first guide mechanism GM1 including the first parallel springs. This configuration also brings about an effect that the movement of the second movable body 5 along the second movement direction can be appropriately and stably guided by the second guide mechanism GM2 including the second parallel springs.

At least one of the pair of first flat spring portions FS1 or the pair of second flat spring portions FS2 may be formed integrally. The first flat spring portions FS1 of the pair may be formed as separate components, and the second flat spring portions FS2 of the pair may be formed as separate components.

The configuration in which the pair of first flat spring portions FS1 is integrally formed brings about an effect that the number of components can be reduced as compared to a configuration in which the first flat spring portions FS1 of the pair of are formed as separate components. The configuration in which the pair of first flat spring portions FS1 is integrally formed also brings about an effect that the positional accuracy of the optical element driving device 101 (the positional accuracy of the optical element OE driven by the optical element driving device 101) can be enhanced because mounting errors with respect to at least one of the base member 3 or the first movable body 4 are suppressed as compared to the configuration in which the first flat spring portions FS1 of the pair are formed as separate components.

The configuration in which the pair of second flat spring portions FS2 is integrally formed brings about an effect that the number of components can be reduced as compared to a configuration in which the pair of second flat spring portions FS2 is formed as separate components. The configuration in which the pair of second flat spring portions FS2 is integrally formed also brings about an effect that the positional accuracy of the optical element driving device 101 can be enhanced because the mounting errors with respect to at least one of the first movable body 4 or the second movable body 5 are suppressed as compared to the configuration in which the second flat spring portions FS2 of the pair of are formed as separate components.

The pair of first flat spring portions FS1 and the pair of second flat spring portions FS2 may be formed integrally. The pair of first flat spring portions FS1 and the pair of second flat spring portions FS2 may be formed separately.

The configuration in which the pair of first flat spring portions FS1 and the pair of second flat spring portions FS2 are integrally formed has an effect that the number of components can be reduced as compared to a configuration in which the pair of first flat spring portions FS1 and the pair of second flat spring portions FS2 are formed separately. The configuration in which the pair of first flat spring portions FS1 and the pair of second flat spring portions FS2 are integrally formed also brings about an effect that the positional accuracy of the optical element driving device 101 can be enhanced because the mounting errors with respect to at least one of the base member 3, the first movable body 4, or the second movable body 5 are suppressed as compared to the configuration in which the pair of first flat spring portions FS1 and the pair of second flat spring portions FS2 are formed separately.

As illustrated in FIG. 3, the first movable body 4 may have the first extending portion EL1 extending in the first movement direction (the X-axis direction) and the second extending portion EL2 extending in the second movement direction. The second movable body 5 may have the third extending portion EL3 extending in the second movement direction (the Y-axis direction). In this case, as illustrated in FIG. 9, the second extending portion EL2 and the third extending portion EL3 may be disposed such that at least a part thereof is located at the same height in the up-down direction and is separated in the first movement direction (the X-axis direction) with the optical element holding member 2 interposed therebetween. As illustrated in FIG. 3, one end portion FS2F of each of the pair of second flat spring portions FS2 in the first movement direction may be fixed to the second extending portion EL2, and the other end portion FS2S of each of the pair of second flat spring portions FS2 in the first movement direction may be fixed to the third extending portion EL3. In the illustrated example, as illustrated in FIG. 9, the second extending portion EL2 extends at a position higher than the first extending portion EL1 in the up-down direction. As illustrated in FIG. 8, the right end portion RE, which is one end portion of the third extending portion EL3 of the second movable body 5, is disposed on the first extending portion EL1 of the first movable body 4. In the illustrated example, as illustrated in the lower diagram of FIG. 9, the upper end surface of the second extending portion EL2 and the upper end surface of the third extending portion EL3 are located at the same height H1 with respect to the level of the lower surface of the base 3B of the base member 3, and the lower end surface of the second extending portion EL2 and the lower end surface of the third extending portion EL3 are located at the same height H2 with respect to the level of the lower surface of the base 3B of the base member 3. The height HT1 of the first extending portion EL1, the height HT2 of the second extending portion EL2, and the height HT3 of the third extending portion EL3 are all the same.

This configuration brings about an effect of suppressing an increase in the length of the optical element driving device 101 in the up-down direction (the Z-axis direction), compared to a configuration in which the second extending portion EL2 and the third extending portion EL3 are not located at the same height in the up-down direction.

As illustrated in the lower diagram of FIG. 11, the base member 3 may have a base 3B in which the opening 3K is formed, and a protrusion 3P protruding upward (to the side on which the first movable body 4 is disposed) from the base 3B. In this case, one end portion FS1F of each of the pair of first flat spring portions FS1 in the second movement direction (the Y-axis direction) may be fixed to the protrusion 3P. In the illustrated example, one end portion FS1F, which is the left end portion of the first flat spring portion FS1 on the front side (the X1 side), is fixed to the left front protrusion 3PFL by an adhesive, and one end portion FS1F, which is the left end portion of the first flat spring portion FS1 on the rear side (the X2 side), is fixed to the left rear protrusion 3PBL by an adhesive.

This configuration brings about an effect of being easier to assemble than a configuration without the protrusion 3P, in other words, an effect of being easier to attach the one end portion FS1F of each of the pair of first flat spring portions FS1 to the base member 3.

As illustrated in FIG. 3 and the lower drawing of FIG. 11, the one end portion FS1F of each of the pair of first flat spring portions FS1 may have a third bent portion FD3 bent inward substantially perpendicularly from the left end of the one end portion FS1F. The third bent portion FD3 may include a fourth bent portion FD4 bent rightward from the upper end portion of the third bent portion FD3. Each of the third bent portion FD3 and the fourth bent portion FD4 may be fixed to the protrusion 3P by an adhesive. In the illustrated example, the one end portion FS1F, which is the left end portion of the first flat spring portion FS1 on the front side (the X1 side), has the third bent portion FD3 and the fourth bent portion FD4, and the one end portion FS1F, which is the left end portion of the first flat spring portion FS1 on the rear side (the X2 side), has the third bent portion FD3 but does not have the fourth bent portion FD4.

This configuration brings about an effect of increasing the adhesive strength between the one end portion FS1F of each of the pair of first flat spring portions FS1 and the protrusion 3P, compared to a configuration without the third bent portion FD3 and the fourth bent portion FD4.

As illustrated in FIG. 3 and the upper drawing of FIG. 11, the other end portion FS2S of each of the pair of second flat spring portions FS2 may have a fifth bent portion FD5 bent inward substantially perpendicularly from the front end of the other end portion FS2S. The fifth bent portion FD5 may include a sixth bent portion FD6 bent rearward from the upper end portion of the fifth bent portion FD5. Each of the fifth bent portion FD5 and the sixth bent portion FD6 may be fixed to the third extending portion EL3 of the second movable body 5 by an adhesive.

This configuration brings about an effect of increasing the adhesive strength between the other end portion FS2S of each of the pair of second flat spring portions FS2 and the third extending portion EL3, compared to a configuration without the fifth bent portion FD5 and the sixth bent portion FD6.

As illustrated in FIGS. 7 through 10, the base 3B of the base member 3 and the first movable body 4 may be separated from each other in the up-down direction. The first movable body 4 and the second movable body 5 may be separated from each other in the up-down direction. In other words, the first movable body 4 may be supported by the first guide mechanism GM1 so as not to contact the base 3B of the base member 3. The second movable body 5 may be supported by the second guide mechanism GM2 so as not to contact the base 3B of the base member 3 and the first movable body 4.

This configuration brings about an effect of reducing the influence of friction caused by contact between components. In addition, this configuration brings about an effect that the thrust of the driver (piezoelectric driver PD) necessary for moving the movable-side member MB can be reduced by at least the amount of reduction in the influence of friction.

As illustrated in FIG. 12, the second movable body 5 may support the optical element holding member 2 via the upper leaf spring member PSU and the lower leaf spring member PSD that support the optical element holding member 2 movably in the third movement direction (the Z-axis direction). In this case, the second movable body 5 may be provided with the third piezoelectric driver PD3 that moves the optical element holding member 2 in the third movement direction (the Z-axis direction). In the illustrated example, the third piezoelectric driver PD3 is attached to the third biasing member 6C fixed to the second movable body 5.

This configuration brings about an effect that an autofocus function can be realized in the camera module CM in which the optical element OE is the lens body LS, for example. Since all of the movements of the lens body LS in the three axial directions can be realized by a piezoelectric method in this configuration, this configuration brings about an effect of preventing a magnetic influence from being exerted on a device (for example, a device including a magnet, a coil, and the like) disposed adjacent thereto.

The central portion of the second piezoelectric driver PD2 in the extending direction (the X-axis direction) may be configured to be able to separately realize an up-down movement and a circular motion. In other words, the second piezoelectric element 8B (second piezoelectric driver PD2) may be configured to be able to separately realize an up-down movement and a circular motion, like the first piezoelectric element 8A (the first piezoelectric driver PD1) described with reference to FIG. 6. Specifically, the second piezoelectric element 8B may be configured to realize the up-down movement when moving the first movable body 4 along the first movement direction (the X-axis direction) and to realize a circular motion when moving the second movable body 5 along the second movement direction (the Y-axis direction).

With this configuration, when the piezoelectric driver PD moves the first movable body 4 along the first movement direction (the X-axis direction) by the circular motion of the first piezoelectric element 8A, the piezoelectric driver PD can move the second piezoelectric element 8B up and down even when the second movable body 5 is not moved along the second movement direction (the Y-axis direction) by the circular motion of the second piezoelectric element 8B. Therefore, the piezoelectric driver PD moves the second piezoelectric element 8B up and down in synchronization with the circular motion of the first piezoelectric element 8A, and thereby, it is possible to prevent the movement of the second movable body 5 moving along the first movement direction (the X-axis direction) together with the first movable body 4 from being hindered by the second piezoelectric driver PD2. This is because the second contact member 9B of the second piezoelectric driver PD2 can be moved away from the second receiving member RC2 at the timing when the second movable body 5 moves along the first movement direction (the X-axis direction) together with the first movable body 4 by the circular motion of the first piezoelectric element 8A. In other words, this is because a state in which the second contact member 9B and the second receiving member RC2 are not in contact with each other can be realized.

As illustrated in FIG. 3, the first guide mechanism GM1 may include a first guide spring member GS1 formed of a metallic plate. In this case, the first guide spring member GS1 may include the first coupling portion CN1 and the pair of first flat spring portions FS1. The first coupling portion CN1 may be configured to realize at least one of coupling of the one end portion FS1F of each of the pair of first flat spring portions FS1 and coupling of the other end portion FS1S of each of the pair of first flat spring portions FS1. The pair of first flat spring portions FS1 and the first coupling portion CN1 may be formed integrally. In the illustrated example, the first coupling portion CN1 is configured to couple the other end portions FS1S of the pair of first flat spring portions FS1. The pair of first flat spring portions FS1 and the first coupling portion CN1 are formed integrally.

The configuration in which the pair of first flat spring portions FS1 and the first coupling portion CN1 are integrally formed brings about an effect that the number of components can be reduced as compared to a configuration in which the pair of first flat spring portions FS1 and the first coupling portion CN1 are formed as separate components. The configuration in which the pair of first flat spring portions FS1 and the first coupling portion CN1 are integrally formed brings about an effect of being able to enhance the positional accuracy of the optical element driving device 101 because the mounting errors with respect to at least one of the base member 3 and the first movable body 4 are suppressed as compared to the configuration in which the pair of first flat spring portions FS1 and the first coupling portion CN1 are formed as separate components.

As illustrated in FIG. 3, the first coupling portion CN1 may include the first flat-plate-shaped portion FP1 that extends in the first movement direction (the X-axis direction) and has a plate surface perpendicular to the second movement direction (the Y-axis direction). In this case, the first movable body 4 may have the first extending portion EL1 extending in the first movement direction, and the first coupling portion CN1 may be fixed to the first extending portion EL1.

The first guide mechanism GM1 including the first coupling portion CN1 as described above brings about an effect of facilitating the production of the first guide mechanism GM1. This is because the first guide mechanism GM1 including the first coupling portion CN1 is easily formed by bending a metallic plate.

As illustrated in FIG. 3, the first coupling portion CN1 may include a first bent portion FD1 that is bent substantially perpendicularly from an end portion of the first flat-plate-shaped portion FP1 in the up-down direction. The first bent portion FD1 may be fixed to the first extending portion EL1. In the illustrated example, the first coupling portion CN1 has the first bent portion FD1 bent inward substantially perpendicularly from a lower end portion of the first flat-plate-shaped portion FP1, and the first bent portion FD1 is fixed to the first extending portion EL1 in a state of being positioned by the first extending portion EL1.

This configuration brings about an effect of increasing the rigidity of the first coupling portion CN1. This configuration also brings about an effect that the first bent portion FD1 can be used for positioning between the first guide mechanism GM1 and the first movable body 4. The configuration in which the lower end portion is bent instead of the upper end portion brings about an effect that interference between the second flat spring portions FS2 and the first coupling portion CN1 can be prevented. The first coupling portion CN1 may include, however, a bent portion bent inward substantially perpendicularly from the upper end portion of the first flat-plate-shaped portion FP1 and a bent portion bent inward substantially perpendicularly from the lower end portion of the first flat-plate-shaped portion FP1. This is to further increase the rigidity of the first coupling portion CN1.

As illustrated in FIG. 3, the second guide mechanism GM2 may include the second guide spring member GS2 formed of a metallic plate. In this case, the second guide spring member GS2 may include the second coupling portion CN2 and the pair of second flat spring portions FS2. The second coupling portion CN2 may be configured to realize at least one of coupling of the one end portion FS2F of each of the pair of second flat spring portions FS2 and coupling of the other end portion FS2S of each of the pair of second flat spring portions FS2. The pair of second spring portions FS2 and the second coupling portion CN2 may be formed integrally. In the illustrated example, the second coupling portion CN2 is configured to couple the one end portions FS2F of the pair of second flat spring portions FS2. The pair of second flat spring portions FS2 and the second coupling portion CN2 are formed integrally.

The configuration in which the pair of second flat spring portions FS2 and the second coupling portion CN2 are integrally formed brings about an effect that the number of components can be reduced as compared to a configuration in which the pair of second flat spring portions FS2 and the second coupling portion CN2 are formed as separate components. The configuration in which the pair of second flat spring portions FS2 and the second coupling portion CN2 are integrally formed also brings about an effect that the positional accuracy of the optical element driving device 101 can be enhanced because the mounting errors with respect to at least one of the first movable body 4 or the second movable body 5 are suppressed as compared to the configuration in which the pair of second flat spring portions FS2 and the second coupling portion CN2 are formed as separate components.

As illustrated in FIG. 3, the second coupling portion CN2 may include the second flat-plate-shaped portion FP2 that extends in the second movement direction (the Y-axis direction) and has a plate surface perpendicular to the first movement direction (the X-axis direction). In this case, the first movable body 4 may have the second extending portion EL2 extending in the second movement direction, and the second coupling portion CN2 may be fixed to the second extending portion EL2 or the second movable body 5. In the illustrated example, the second coupling portion CN2 is fixed to the second extending portion EL2.

The second guide mechanism GM2 including the second coupling portion CN2 as described above brings about an effect of facilitating the production of the second guide mechanism GM2. This is because the second guide mechanism GM2 including the second coupling portion CN2 is easily formed by bending a metallic plate.

As illustrated in FIG. 3, the second coupling portion CN2 may include a second bent portion FD2 that is bent substantially perpendicularly from an end portion of the second flat-plate-shaped portion FP2 in the up-down direction. The second bent portion FD2 may be fixed to the second extending portion EL2 or the second movable body 5. In the illustrated example, the second coupling portion CN2 has the second bent portion FD2 bent inward substantially perpendicularly from a upper end portion of the second flat-plate-shaped portion FP2, and the second bent portion FD2 is fixed to the second extending portion EL2 in a state of being positioned by the second extending portion EL2 of the first movable body 4.

This configuration brings about an effect of increasing the rigidity of the second coupling portion CN2. This configuration also brings about an effect that the second bent portion FD2 can be used for positioning between the second guide mechanism GM2 and the movable-side member MB (the first movable body 4). The configuration in which the upper end portion is bent instead of the lower end portion brings about an effect that interference between the first flat spring portions FS1 and the second coupling portion CN2 can be prevented. The second coupling portion CN2 may include, however, a bent portion bent inward substantially perpendicularly from the upper end portion of the second flat-plate-shaped portion FP2 and a bent portion bent inward substantially perpendicularly from the lower end portion of the second flat-plate-shaped portion FP2. This is to further increase the rigidity of the second coupling portion CN2.

As illustrated in FIGS. 3 and 11, the first guide spring member GS1 and the second guide spring member GS2 may be connected to each other by the third coupling portion CN3 and formed integrally. In the illustrated example, the third coupling portion CN3 having an approximately L-shaped cross section in top view couples the rear end portion (the end portion on the X2 side) of the first coupling portion CN1 (the first flat-plate-shaped portion FP1) and the other end portion FS1S of the first flat spring portion FS1 positioned on the rear side (the X2 side) to the right end portion (the end portion on the Y2 side) of the second coupling portion CN2 (the second flat-plate-shaped portion FP2) and the one end portion FS2F of the second flat spring portion FS2 positioned on the right side (the Y2 side). Furthermore, the first guide mechanism GM1 (the first guide spring member GS1) and the second guide mechanism GM2 (the second guide spring member GS2) are integrally formed to form one component. In FIG. 3, for the sake of clarity, the third coupling portion CN3 is illustrated in a dot pattern.

The configuration in which the first guide spring member GS1 and the second guide spring member GS2 are integrally formed has an effect that the number of components can be reduced as compared to a configuration in which the first guide spring member GS1 and the second guide spring member GS2 are formed as separate components. The configuration in which the first guide spring member GS1 and the second guide spring member GS2 are integrally formed also brings about an effect that the positional accuracy of the optical element driving device 101 can be enhanced because the mounting errors with respect to at least one of the base member 3, the first movable body 4, or the second movable body 5 are suppressed as compared to the configuration in which the first guide spring member GS1 and the second guide spring member GS2 are formed as separate components.

As illustrated in FIG. 11, the flat spring portion FS having the pair of first flat spring portions FS1 and the pair of second flat spring portions FS2 may be formed in such a manner that the outer shape thereof is substantially rectangular in a plan view along the up-down direction. In this case, the first coupling portion CN1 may couple the other end portion FS1S of each of the pair of first flat spring portions FS1 as illustrated in the lower diagram of FIG. 11, the second coupling portion CN2 may couple the one end portion FS2F of each of the pair of second flat spring portions FS2 as illustrated in the upper diagram of FIG. 11, and the third coupling portion CN3 may be provided at a position corresponding to one of four corner portions of the substantially rectangular shape where the one end portion of the first coupling portion CN1 and the one end portion of the second coupling portion CN2 are disposed as illustrated in the lower diagram of FIG. 11. In the illustrated example, the outer shape of the flat spring portion FS is substantially rectangular and has four corner portions CR (the first corner portion CR1 through the fourth corner portion CR4), and the third coupling portion CN3 is provided at a position corresponding to the fourth corner portion CR4.

This configuration brings about an effect that the elastic deformation of one flat spring portion FS (e.g., the first flat spring portions FS1) can be suppressed from being affected by the elastic deformation of another flat spring portion FS (e.g., the second flat spring portions FS2), compared to a configuration in which the third coupling portion CN3 is provided at a position corresponding to the first corner portion CR1, the second corner portion CR2, or the third corner portion CR3.

The preferred embodiment of the present disclosure has been described in detail above. However, the present invention is not limited to the above-described embodiment. Various modifications or substitutions may be applied to the above-described embodiment without departing from the scope of the present invention. The features described with reference to the embodiments may be appropriately combined as long as there is no technical contradiction.

For example, in the above-described embodiment, the first biasing member 6A that brings the first contact member 9A and the first receiving member RC1 of the first piezoelectric driver PD1 into contact with each other so as to press each other is configured by one member formed of a metallic plate; however, the first biasing member 6A may be configured by combining a plurality of metallic plates. The same applies to the second biasing member 6B and the third biasing member 6C.

In the above-described embodiment, the first biasing member 6A and the second biasing member 6B are assembled to the base member 3 (base 3B) from the upper side of the base member 3; however, the first biasing member 6A and the second biasing member 6B may be assembled to the base member 3 (base 3B) from the lower side of the base member 3 by providing a penetration portion in the base member 3 (base 3B).

In the above-described embodiment, the pair of first flat spring portions FS1 included in the first guide mechanism GM1 are integrally formed by being connected by the first coupling portion CN1 (first flat-plate-shaped portion FP1); however, the pair of first flat spring portions FS1 may be formed as separate components. In this case, it is preferred that the pair of first flat spring portions FS1 are formed of metallic plates having the same shape and the same size. This is because an increase in the number of types of components can be suppressed. The same applies to the pair of second flat spring portions FS2 included in the second guide mechanism GM2, and the second flat spring portions FS2 may be constituted by separate components (metallic plates) having the same shape and the same size. In the case where the pair of first flat spring portions FS1 and the pair of second flat spring portions FS2 are formed as separate components, it is desirable that the components be formed of strip-shaped metal plates. This is because it is not necessary to perform bending on the component, and the manufacturing cost can be suppressed.

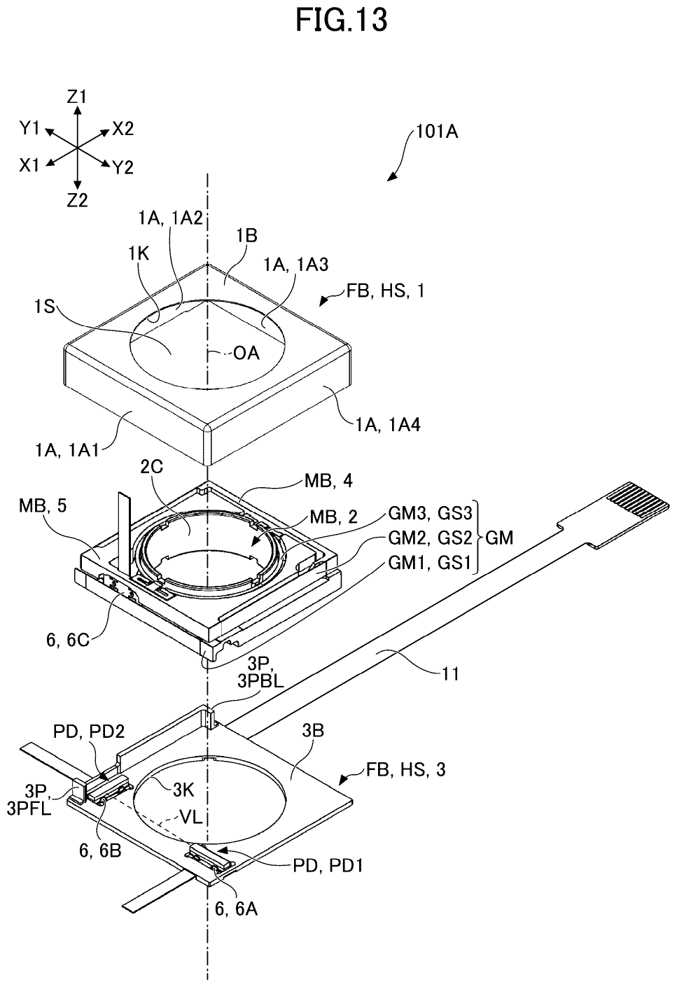

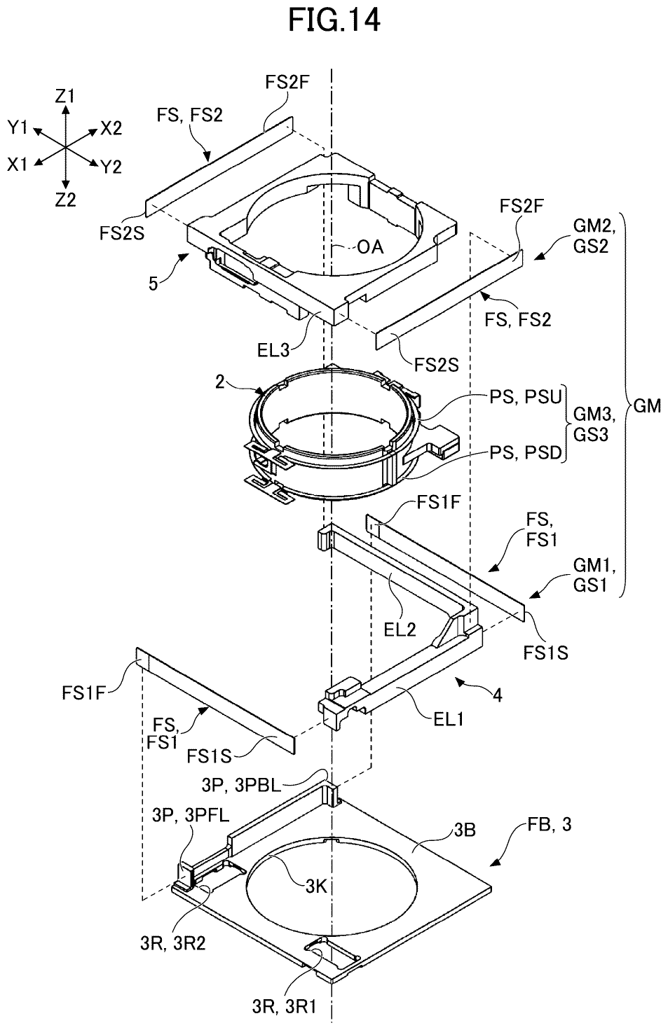

Herein, an optical element driving device 101A, which is another configuration example of the optical element driving device 101, will be described with reference to FIGS. 13 and 14. FIG. 13 is an exploded perspective view of the optical element driving device 101A, and corresponds to FIG. 2. FIG. 14 is an exploded perspective view of the optical element holding member 2, the base member 3, the first movable body 4, the second movable body 5, and the guide mechanism GM constituting the optical element driving device 101A, and corresponds to FIG. 3.

The optical element driving device 101A differs from the optical element driving device 101 in that the first biasing member 6A and the second biasing member 6B are assembled to the base member 3 (base 3B) from the lower side of the base member 3 with respect to the penetration portion 3R (see FIG. 14) formed in the base 3B. Specifically, in the optical element driving device 101A, as illustrated in FIG. 13, the first biasing member 6A and the second biasing member 6B are respectively accommodated in the first penetration portion 3R1 and the second penetration portion 3R2 provided in the base 3B. On the other hand, in the optical element driving device 101, as illustrated in FIG. 4, the first biasing member 6A and the second biasing member 6B are respectively accommodated in the first recess 301 and the second recess 302 provided in the base 3B.

The optical element driving device 101A differs from the optical element driving device 101 in that the first guide mechanism GM1 includes, as the first guide spring member GS1, a pair of first flat spring portions FS1 that is a pair of strip-shaped metal plates. This is because, in the optical element driving device 101, the pair of first flat spring portions FS1 are coupled by the first coupling portion CN1 as illustrated in FIG. 3. The optical element driving device 101A differs from the optical element driving device 101 in that the second guide mechanism GM2 includes, as the second guide spring member GS2, a pair of second flat spring portions FS2 that is a pair of strip-shaped metal plates. This is because, in the optical element driving device 101, the pair of second flat spring portions FS2 are coupled by the second coupling portion CN2 as illustrated in FIG. 3.

Specifically, in the optical element driving device 101A, the first flat spring portions FS1, which are a pair of strip-shaped metallic plates, is formed of metallic plates having the same shape and the same size, and the second flat spring portions FS2, which are a pair of strip-shaped metallic plates, is also formed of metallic plates having the same shape and the same size. Furthermore, the metallic plates constituting the first flat spring portions FS1 and the metallic plates constituting the second flat spring portions FS2 are configured to have the same shape and the same size. In other words, the four strip-shaped metal plates are configured to have the same shape and the same size.

One end portion FS1F of each of the pair of first flat spring portions FS1 in the second movement direction (the Y-axis direction) is fixed to the fixed-side member FB (protrusion 3P of the base member 3) by an adhesive, and the other end portion FS1S of each of the pair of first flat spring portions FS1 in the second movement direction (the Y-axis direction) is fixed to the first extending portion EL1 of the first movable body 4 by an adhesive. Similarly, one end portion FS2F of each of the pair of second flat spring portions FS2 in the first movement direction (the X-axis direction) is fixed to the second extending portion EL2 of the first movable body 4 by an adhesive, and the other end portion FS2S of each of the pair of second flat spring portions FS2 in the first movement direction (the X-axis direction) is fixed to the third extending portion EL3 of the second movable body 5 by an adhesive.

Although the piezoelectric driver PD is adopted as a driver in the above-described embodiment, the guide mechanism GM may be applied to an optical element driving device in which a voice coil motor, a shape memory alloy wire, or the like is adopted as the driver.

What is claimed is:

1. An optical element driving device, comprising:
a fixed-side member including a base member;
an optical element holding member having a penetration portion that penetrates in an up-down direction and is capable of holding an optical element;
a first movable body disposed on one surface side of the base member and configured to be movable in a first movement direction that intersects with the up-down direction with respect to the fixed-side member;
a second movable body disposed on the one surface side of the base member, configured to be movable in a second movement direction that intersects with the up-down direction with respect to the first movable body and is perpendicular to the first movement direction, and configured to support the optical element holding member;
a first driver configured to move the first movable body in the first movement direction;
a second driver configured to move the second movable body in the second movement direction;
a first guide mechanism configured to guide movement of the first movable body in the first movement direction; and
a second guide mechanism configured to guide movement of the second movable body in the second movement direction, wherein
the first guide mechanism includes a pair of first flat spring portions facing each other in parallel and separated in the first movement direction and extending in the second movement direction,
the pair of first flat spring portions have respective plate surfaces perpendicular to the first movement direction,
one end portion of each of the pair of first flat spring portions in the second movement direction is fixed to the fixed-side member,
an other end portion of each of the pair of first flat spring portions in the second movement direction is fixed to the first movable body,
the second guide mechanism includes a pair of second flat spring portions facing each other in parallel and separated in the second movement direction and extending in the first movement direction,
the pair of second flat spring portions have respective plate surfaces perpendicular to the second movement direction,
one end portion of each of the pair of second flat spring portions in the first movement direction is fixed to the first movable body, and
an other end portion of each of the pair of second flat spring portions in the first movement direction is fixed to the second movable body.

2. The optical element driving device according to claim 1, wherein
at least one of the pair of first flat spring portions or the pair of second flat spring portions is formed integrally.

3. The optical element driving device according to claim 2, wherein
the pair of first flat spring portions and the pair of second flat spring portions are formed integrally.

4. The optical element driving device according to claim 1, wherein
the first flat spring portions of the pair are formed separately, and
the second flat spring portions of the pair are formed separately.

5. The optical element driving device according to claim 2, wherein
the first guide mechanism includes a first guide spring member formed of a metal plate,
the first guide spring member includes a first coupling portion and the pair of first flat spring portions, and
the first coupling portion realizes at least one of coupling of the one end portions of the pair of first flat spring portions or coupling of the other end portions of the pair of first flat spring portions.

6. The optical element driving device according to claim 5, wherein
the first coupling portion includes a first flat-plate-shaped portion extending in the first movement direction and having a plate surface perpendicular to the second movement direction,
the first movable body includes a first extending portion extending in the first movement direction, and
the first coupling portion is fixed to the first extending portion.

7. The optical element driving device according to claim 6, wherein
the first coupling portion includes a first bent portion bent substantially perpendicularly from an end portion of the first flat-plate-shaped portion in the up-down direction, and
the first bent portion is fixed to the first extending portion.

8. The optical element driving device according to claim 5, wherein
the second guide mechanism includes a second guide spring member formed of a metal plate,
the second guide spring member includes a second coupling portion and the pair of second flat spring portions, and
the second coupling portion realizes at least one of coupling of the one end portions of the pair of second flat spring portions or coupling of the other end portions of the pair of second flat spring portions.

9. The optical element driving device according to claim 8, wherein
the second coupling portion includes a second flat-plate-shaped portion extending in the second movement direction and having a plate surface perpendicular to the first movement direction,
the first movable body includes a second extending portion extending in the second movement direction, and
the second coupling portion is fixed to the second extending portion or the second movable body.

10. The optical element driving device according to claim 9, wherein
the second coupling portion includes a second bent portion bent substantially perpendicularly from an end portion of the second flat-plate-shaped portion in the up-down direction, and
the second bent portion is fixed to the second extending portion or the second movable body.

11. The optical element driving device according to claim 8, wherein
the first guide spring member and the second guide spring member are coupled to each other by a third coupling portion and are formed integrally.

12. The optical element driving device according to claim 11, wherein
an outer shape of a flat spring portion including the pair of first flat spring portions and the pair of second flat spring portions is a substantially rectangular shape in a plan view along an up-down direction,
the first coupling portion couples the other end portions of the pair of first flat spring portions to each other,
the second coupling portion couples the one end portions of the pair of second flat spring portions to each other, and
the third coupling portion is provided at a position corresponding to one of four corners of the substantially rectangular shape at which one end portion of the first coupling portion and one end portion of the second coupling portion are disposed.

13. The optical element driving device according to claim 1, wherein
the first movable body includes a first extending portion extending in the first movement direction and a second extending portion extending in the second movement direction,
the second movable body includes a third extending portion extending in the second movement direction,
the second extending portion and the third extending portion are at least partially located at a same height in the up-down direction and are disposed apart from each other in the first movement direction, with the optical element holding member being interposed therebetween,
the one end portion of each of the pair of second flat spring portions in the first movement direction is fixed to the second extending portion, and
the other end portion of each of the pair of second flat spring portions in the first movement direction is fixed to the third extending member.

14. The optical element driving device according to claim 1, wherein
the base member includes a base having an opening formed in the base and a protrusion protruding upward from the base, and
the one end portion of each of the pair of first flat spring portions in the second movement direction is fixed to the protrusion.

15. The optical element driving device according to claim 14, wherein
the base of the base member and the first movable body are spaced apart from each other in the up-down direction, and
the first movable body and the second movable body are spaced apart from each other in the up-down direction.

16. The optical element driving device according to claim 1, wherein
the second movable body supports the optical element holding member via an upper leaf spring member and a lower leaf spring member each configured to support the optical element holding member so as to be movable in the up-down direction, and
the second movable body is provided with a third driver configured to move the optical element holding member in the up-down direction.

17. A camera module comprising:
the optical element driving device according to claim 1;
a lens body held by the optical element holding member; and
an imaging element disposed to face the lens body.
